(19) United States
(12) Patent Application Publication
(10) Pub. No.: US 2005/0133774 A1
(43) Pub. Date: Jun. 23, 2005

(54) Drive-through force transmission device and methods

(75) Inventor: Dwayne Creston Long, Neenah, WI (US)

Correspondence Address: WILHELM LAW SERVICE, S.C., 100 W LAWRENCE ST, THIRD FLOOR, APPLETON, WI, 54911, US

(73) Assignee: Waupaca Elevator Company, Inc., Appleton, WI (US)

(21) Appl. No.: 10/994,094

(22) Filed: Nov. 19, 2004

Related U.S. Application Data
(60) Provisional application No. 60/526,693, filed on Dec. 3, 2003.

(51) Int. Cl. B66D 1/14

(52) U.S. Cl. 254/365

(57) ABSTRACT

A force transmission device comprises a winding drum, a force converter, and a clutch/brake. The force converter communicates with both the winding drum and the clutch/brake. The force converter is adapted to convert a torsional force in the winding drum, into axial force/movement. The axial force/movement applies a clutch-type driving force. The clutch/brake can also apply a radially-directed braking force, whereby the force converter provides mechanical load compensation.

### CROSS REFERENCE TO RELATED APPLICATIONS

This application is a Non-Provisional Application, claiming priority under 35 U.S.C. 119(e) to U.S. Provisional Application Ser. No. 60/526,693, filed Dec. 3, 2003, which is incorporated herein by reference in its entirety.

### BACKGROUND

This invention relates to apparatus for lifting/lowering, manipulating and/or otherwise controlling loads. Such lifting/lowering devices include winches, elevator drive mechanisms, dumb waiter drive mechanisms, and others. This invention also relates to methods of manipulating and/or otherwise controlling loads, and to methods of operating such apparatus.

Specifically, this invention relates to braking devices used in conjunction with lifting/lowering devices to control the lifting/lowering, manipulating and/or otherwise controlling of loads.

Conventional lifting/lowering devices comprise a drive unit such as a motor or other prime mover, and an associated winding unit which is driven by the prime mover. In some conventional lifting/lowering devices, the prime mover directly rotates the winding unit. Typically, however, a gear box provides the interface between the prime mover and the winding unit. The gear box can be integral with the prime mover, integral with the winding unit, or may be a standalone separate and distinct unit, which is not part of either the prime mover or the winding unit.

Some lifting/lowering devices further comprise a brake to additionally control the lifting/lowering, manipulating and/or otherwise controlling of a load. Such brake can be of a plate-type design, a drum-type design, or other design.

Typical plate-type brakes incorporate at least one relatively stationary device, e.g. stator disc, which does not rotate about an axis, and at least one relatively mobile device, e.g. rotor disc, which correspondingly rotates with the winding unit. A biasing unit urges the rotor disc/discs and the stator disc/discs into intimate communication, whereby the friction between the rotor disc/discs and the stator disc/discs is effective to slow and/or stop the rotation of the rotor disc/discs and correspondingly slow and/or stop the rotation of the winding drum.

Other known plate-type braking devices utilize a rotor and biasing units, without stator discs. Such plate-type braking devices rely on the frictional force between the rotor and the biasing unit to slow and/or stop the rotation of the rotor and correspondingly slow and/or stop the rotation of the winding drum.

Conventional biasing units of plate-type braking devices cyclically increase and decrease, including engage and release, the axial load applied by the biasing unit, accordingly raising and lowering the load being addressed by the braking device. Typically, fluid pressure, e.g. pneumatic pressure or hydraulic pressure, forces the axial movement of the biasing unit. However, some plate-type braking devices utilize electrical energy, or an electromechanical process to effect axial movement of the biasing unit.

Creating ancillary force to operate a biasing unit of a braking device requires energy consumption. In addition, the effectiveness of the biasing unit in a braking device is related to, and limited by, the ancillary force used, and the integrity of the transmission of such ancillary force to the biasing unit.

Therefore, it is an object of this invention to provide force transmission devices which utilize mechanical load compensation as a braking component.

It is another object of the invention to provide force transmission devices having drive through braking capability.

### SUMMARY

This invention provides novel force transmission devices, and novel methods of lifting/lowering, manipulating and/or otherwise controlling loads. Force transmission devices of the invention use gravitational energy, applied to a suspended load, to realize a mechanical load compensation. The mechanical load compensation is embodied by a braking force applied to the lifting/lowering apparatus as powered, at least in part, by the potential energy and/or kinetic energy of a load suspended by the lifting/lowering apparatus.

In a first family of embodiments, the invention comprehends a force transmission device, comprising: (a) a prime mover; (b) a clutch/brake assembly communicating with the prime mover; (c) a winding drum communicating with the clutch/brake assembly; and (d) a force converter communicating with the clutch/brake assembly and the winding drum and, the clutch/brake assembly comprising a clutch/brake housing having a housing inner surface, a plurality of discs defining a collective outer perimeter surface, including at spaces between the discs, the discs being generally concentrically disposed within the clutch/brake housing, and at least one braking element disposed between the housing inner circumferential surface and the collective outer perimeter surface of the plurality of discs, thereby to realize a frictional coupling between the discs and the inner surface of the clutch/brake housing.

In some embodiments the at least one braking element communicates with the collective perimeter surface of the plurality of discs; and is adapted and configured to bias between a first position in which the at least one braking element is relatively frictionally engaged with the inner surface of the clutch/brake housing, and a second position in which the at least one braking element is relatively frictionally disengaged with the inner surface of the clutch/brake housing.

In some embodiments, the plurality of discs being adapted to rotate about an axis of rotation, each of the plurality of discs being generally circular and having opposing generally flat surfaces, and defining an outer perimeter, including an imaginary outer circumference, at least one of the discs having a disc land at the corresponding outer perimeter, and extending from such imaginary outer circumference, the land defining an angle greater than zero degrees relative to a tangent to such outer circumference, which tangent touches such imaginary outer circumference at a locus underlying or touching the land.

In some embodiments, the disc land having first and second terminal ends, the at least one braking element being movable along the disc land between a first position in which the at least one braking element is proximate one of the first and second terminal ends of the disc land, and a second position in which the at least one braking element is displaced from one of the first and second terminal ends of the disc land.

In some embodiments, the disc land having first and second terminal ends, the at least one braking element being rotationally movable along the disc land between a first position in which the at least one braking element is proximate one of the first and second terminal ends of the disc land, and a second position in which the at least one braking element is displaced from one of the first and second terminal ends of the disc land.

In some embodiments, the clutch/brake assembly comprises a pressure plate, and at least one clutch disc having a generally serrated outer circumferential surface.

In some embodiments, the clutch/brake assembly further comprises at least one friction disc coaxial with, and adjacent, at least one of the pressure plate and the clutch disc whereby the friction disc is adapted and configured to frictionally engage with at least one of the pressure plate and the clutch disc.

In some embodiments, the force transmission further comprising a drive shaft having a length and an outer circumferential surface and communicating with the prime mover and extending generally medially axially through the clutch/brake assembly and the winding drum.

In some embodiments, the force converter comprises a generally cylindrical body having an outer perimeter surface and at least one groove in the outer perimeter surface.

In some embodiments, the force converter has an axis of rotation and the at least one groove of the generally elongate cylindrical body defines a first groove portion and a second groove portion, one of the first and second groove portions being generally parallel to the axis of rotation and the other of the first and second groove portions extending generally helically along a portion of the outer perimeter surface of the generally cylindrical body of the force converter.

In some embodiments, the force transmission device further comprising a pressure plate having first and second generally annular ends, one of the first and second generally annular ends generally defining a collar, and a cavity extending from the collar inwardly into the pressure plate, the force transmission device yet further comprising a generally cylindrical body having an outer circumferential surface, at least a portion of the generally cylindrical body of the force transmission device being generally slidingly and rotatably housed in at least a portion of the cavity of the pressure plate, the pressure plate being adapted and configured to generally axially slide with respect to, and to generally rotate with respect to, the generally cylindrical body of the force transmission device.

In some embodiments, the pressure plate being adapted and configured to axially and rotatably actuate between a first position in which relatively less of the generally cylindrical body is covered by the pressure plate, and a second position in which relatively more of the generally cylindrical body is covered by the pressure plate.

In some embodiments, wherein when the pressure plate is in the first position, ones of the plurality of discs generally rotationally slip with respect to each other.

In some embodiments, wherein when the pressure plate is in the second position, ones of the plurality of plates generally frictionally couple with respect to each other.

In some embodiments, the at least one braking element communicating with the collective outer perimeter surface of the plurality of plates and generally loosely interfacing with the inner circumferential surface of the clutch/brake housing.

In some embodiments, the at least one braking element communicating with the collective outer perimeter surface of the plurality of plates and generally snugly interfacing with the inner circumferential surface of the clutch/brake housing, whereby the at least one braking element provides frictional braking force against the inner circumferential surface of the clutch/brake housing.

In some embodiments, the force transmission device further comprising an interfacing plate between the disc land and the at least one brake element.

In a second family of embodiments, the invention comprehends a force transmission device, comprising: (a) drive shaft; (b) a force converter comprising a first actuation member and a second actuation member, the force converter being drivingly engaged with the drive shaft; (c) a clutch communicating with the force converter; and (d) a winding drum drivably engaged with the force converter; the first actuation member and the second actuation member being engaged with each other so as to effect axial movement of at least one of the first and second actuation members relative to the other of the first and second actuation members, and wherein the axial movement of the at least one of the first and second actuation members corresponds to respective engagement and/or disengagement of the clutch.

In some embodiments, the device further comprises a brake communicating with the clutch and comprising a brake housing having at least one braking element engagably communicating with the brake housing.

In some embodiments, the brake housing is generally concentric with, and generally surrounds the clutch.

In some embodiments, the clutch defining an outer perimeter surface and the brake housing comprising an inner circumferential surface, at least one braking element communicating with each of the outer perimeter surface of the clutch and the inner circumferential surface of the brake housing.

In some embodiments, the clutch being adapted and configured to rotate about an axis of rotation, the at least one braking element being adapted and configured to bias between a first position in which the braking element is relatively frictionally engaged with the inner surface of the brake housing, and a second position in which the braking element is relatively frictionally disengaged with the inner surface of the brake housing.

In some embodiments, the at least one braking element has a length extending generally parallel to the axis of rotation, the braking element being adapted and configured to move with respect to the disc land.

In some embodiments, the disc having first and second terminal ends, the at least one braking element being slidably moveable along the disc land between a first position in which the at least one braking element is proximate one of the first and second terminal ends of the disc land, and a second position in which the at least one braking element is displaced from the one of the first and second terminal ends of the disc land.

In some embodiments, the force transmission device further comprising an interfacing plate between the disc land and the at least one brake element.

In a third family of embodiments, the invention comprehends a force transmission device comprising: (a) a drive shaft; (b) a force converter drivingly engaged with the drive shaft; and (c) a winding drum drivably engaged with the force converter; the force converter further comprising a first actuation member and a second actuation member, the force converter being adapted and configured so as to enable at least one of the first and second actuation members to axially move relative to the other of the first and second actuation members, whereby a torsional force applied to at least one of the first actuation member and the second actuation member realizes an axial advancement or regression of at least one of the first actuation member and the second actuation member relative to the other one of the first actuation member and the second actuation member.

In some embodiments, wherein the at least one of the first and second actuation members moves axially when a torsional force is applied to the actuation member.

In some embodiments, wherein at least one of the first and second actuation members is adapted and configured to rotate in combination with axial movement relative the other of the first and second actuation members.

In some embodiments, the force transmission device further comprising a pressure plate having first and second generally annular ends, one of the first and second generally annular ends generally defining a collar and a cavity extending from the collar inwardly into the pressure plate, the force transmission device yet further comprising a generally elongate cylindrical body having an outer circumferential surface, at least a portion of the generally cylindrical body of the force transmission device being generally slidingly and rotatably housed in at least a portion of the cavity of the pressure plate, the pressure plate being adapted and configured to generally axially slide with respect to, and to generally rotate with respect to, the generally cylindrical body of the force transmission device.

In some embodiments, wherein the device further comprises a clutch communicating with the force converter and having a plurality of discs generally defining an outer perimeter surface, including space between the discs, and wherein the pressure plate in the first position corresponds to a generally rotationally slipping relationship between ones of the plurality of discs.

In some embodiments, wherein such device further comprises a clutch communicating with the force converter the clutch having a plurality of discs generally defining an outer perimeter surface, including spaces between the discs, and wherein the pressure plate in the second position corresponds to a generally frictional coupling relationship between respective ones of the plurality of discs.

In some embodiments, wherein such device further comprises a brake having a clutch/brake housing which defines an inner circumferential housing surface, and at least one braking element, the at least one braking element communicating with the outer perimeter surface of the plurality of discs and, in the first position, generally loosely interfacing with the inner circumferential surface of the clutch/brake housing.

In some embodiments, wherein the device further comprises a brake, and a clutch/brake housing which defines an inner circumferential housing surface, and at least one braking element, the at least one braking element communicating with the outer perimeter surface of the plurality of discs and, in the second position, generally snugly interfacing with the inner circumferential surface of the clutch/brake housing, whereby the at least one braking element provides a frictional braking force between the inner circumferential surface of the clutch/brake housing and the outer perimeter surface of the plurality of discs.

In some embodiments, wherein the device further comprises a brake housing and a brake element between the brake housing and the plurality of discs, and a interface plate between the brake element and the plurality of discs.

In some embodiments, wherein one of the first and second actuation members has an outer surface, and grooves disposed in the outer surface, and wherein the other one of the first and second actuation members comprises a collar having an inner surface with projections extending inwardly at the inner surface, the projections cooperating with the grooves in the outer surface.

In some embodiments, wherein the grooves in the outer surface are adapted and configure to guide movement of one of the projections of the collar and the other one of the first and second actuation members, upon application of a rotational force to the one of the actuation members, in a direction of an axis extending through the generally cylindrical body.

In some embodiments, the collar having an outer surface communicating with the winding drum whereby a torsional force applied to the winding drum is transferred to the collar.

In some embodiments, wherein the first actuation member comprises a helical gear, and wherein the second actuation member comprises a ring gear cooperatively compatible with the helical gear, the helical gear and the ring gear being rotatably slidingly engaged with each other.

In some embodiments, the force converter being adapted to convert a torque force applied to a first one of the first and second actuation members into axial movement of one of the first and second actuation members.

In a forth family of embodiments, the invention comprehends a drive-through clutch/brake comprising: (a) a clutch assembly including at least one clutch disc, at least one friction disc, a helical gear, and a helical drive; (b) a brake housing; (c) at least one brake element effective to engage the clutch assembly at the at least one clutch disc and/or the at least one friction disc, and the brake housing.

In some embodiments, the clutch assembly capable of rotating in a first direction of driving whereby the at least one brake element is generally disengaged from the brake housing.

In some embodiments, the clutch assembly capable of rotating in a second, opposite, direction of driving whereby the at least one brake element is generally engaged with the brake housing and remains engaged with the brake housing during rotation of the clutch assembly in such second direction.

In a fifth family of embodiments, the invention comprehends a method of automatically controlling a load, comprising: (a) suspending a gravitationally-actuated load from a force transmission device, the force transmission device comprising a winding drum, a force converter, and a brake; (b) transferring the gravitationally actuated load through a cable, to the winding drum and thereby converting the gravitational force to a torsional force; (c) transferring at least some of the force from the winding drum, through the force converter, and into the brake; and (d) converting at least some of the torsional force from the winding drum into axial movement, and thereby developing a braking force in the brake.

In some embodiments, wherein the force transmission device further includes a prime mover, and a drive train connecting the prime mover to the force transmission device, the method further comprising: (e) energizing the prime mover so as to provide a rotational driving force, through the drive train, to the force converter, in a first rotational direction and correspondingly rotating the winding drum in a first direction of rotation and thereby removing at least part of the braking force from the brake; the magnitude of the braking force removed from the brake being sufficient to enable the prime mover to lift the load.

In some embodiments, the method further comprising: (f) energizing the prime mover so as to provide a rotational driving force in a second, opposite rotational direction and correspondingly rotating the winding drum in a second, opposite direction of rotation; and (g) rotating the winding drum with a magnitude of rotational driving force sufficiently great to overcome the braking force provided by the brake; whereby the magnitude of the rotational driving force is sufficiently great to enable the prime mover to drive through the braking force of the brake and correspondingly to lower the load.

In a sixth family of embodiments, the invention comprehends a method of controlling a load, comprising: (a) applying a loading force, in a loading direction, to a force transmission device comprising a force receiver, a force converter, and a brake; (b) applying sufficient braking energy to the brake to prevent the loading force from causing motion; and (c) applying driving energy from a prime mover to the force transmission device, in a direction such that the driving energy force is additive to the loading force, and in sufficient amount to overcome the braking force provided by the brake, thereby to enable movement of the load in accord with the direction of the loading force while the braking energy is being applied.

In some embodiments, the method further comprising: (d) applying driving energy from a prime mover to the force transmission device, in a direction generally opposite the direction of the loading force, and in sufficient amount to reduce the braking force provided by the brake, thereby to enable movement of the load in accord with the direction of the driving energy force and generally opposite the direction of the loading force.

### BRIEF DESCRIPTION OF THE DRAWINGS

FIG. 1A shows a perspective view of a first embodiment of force transmission devices of the invention connected to a load, the load being illustrated in schematic form.

FIG. 1B shows a perspective view of a second embodiment of force transmission devices of the invention connected to a load, the load being illustrated in schematic form.

FIG. 2A shows an exploded perspective view of the winding assembly of the force transmission device of FIG. 1A.

FIG. 2B shows a cross-sectional perspective view of the force transmission device of FIG. 1B, taken along axis of rotation “A.”

FIG. 3A shows an exploded perspective view of a first embodiment of a disc pack assembly of the invention.

FIG. 3B shows an exploded perspective view of a second embodiment of a disc pack assembly of the invention.

FIG. 4 shows a side elevation of a portion of the force transmission device of FIG. 2B, with portions of the winding assembly removed.

FIG. 5 shows a cutaway perspective view of portions of the clutch/brake assembly of the force transmission device of FIG. 2B.

The invention is not limited in its application to the details of construction or the arrangement of the components set forth in the following description or illustrated in the drawings. The invention is capable of other embodiments or of being practiced or carried out in other various ways. Also, it is to be understood that the terminology and phraseology employed herein is for purpose of description and illustration and should not be regarded as limiting. Like reference numerals are used to indicate like components.

### DESCRIPTION OF THE ILLUSTRATED EMBODIMENTS

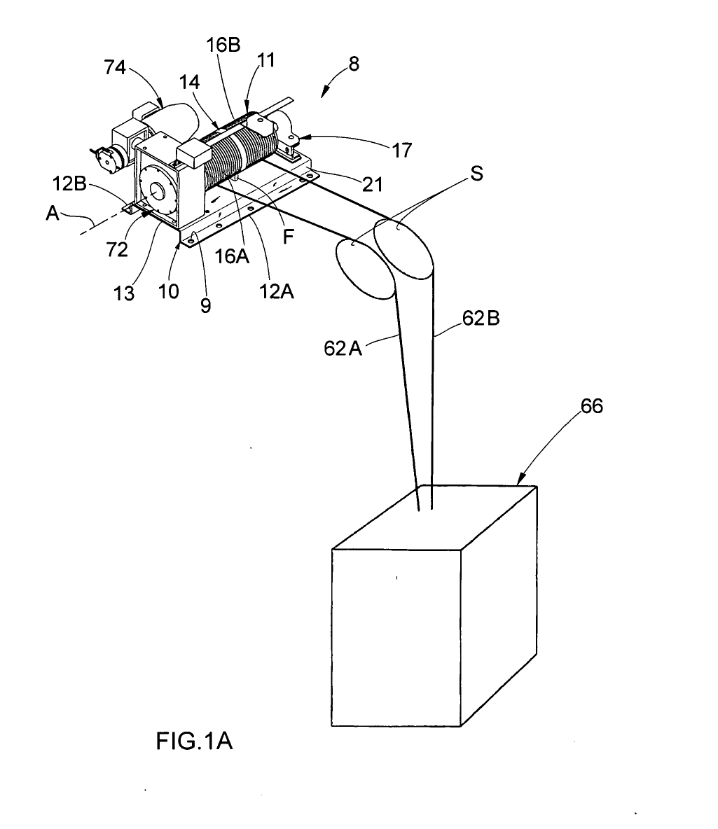

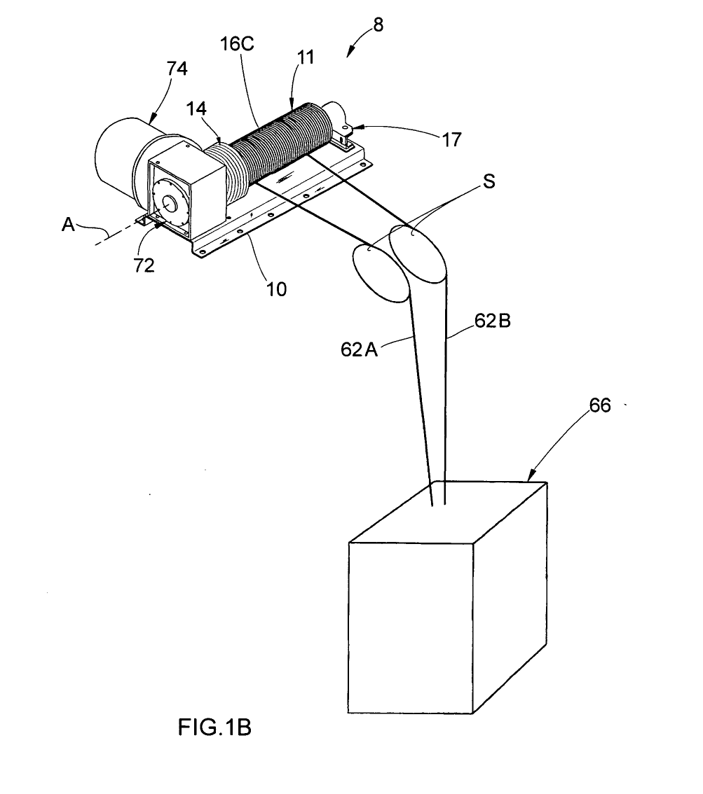

FIG. 1A illustrates a first embodiment of force transmission devices 8 of the invention which are used for lifting, lowering, manipulating and/or otherwise controlling a load; hereinafter referred to as “lifting/lowering” a load. In general, force transmission device 8 has a base plate 10 upon which winding assembly 11, gearbox 72, and a prime mover, e.g. electric motor 74 is each mounted, directly or indirectly. Winding assembly 11 includes first and second winding drums 16A, 16B. Each of the winding drums 16A, 16B has one end of a cable 62A, 62B respectively attached thereto. The other end of each of cables 62A, 62B is attached to, optionally removably attached to, load 66.

As will be described in greater detail hereinafter, force transmission device 8 is adapted and configured (i) to provide a passive braking force when motor 74 is not energized to e.g. resist a generally downward gravitational force applied to load 66, and (ii) to actively drive through the passive braking force so as to actively drive load 66 generally downwardly.

Base plate 10, of force transmission device 8, defines a length dimension, a width dimension, an upper surface a lower surface, first and second lateral portions 12A, 12B, a medial portion 13, and first and second elongate projections 21. The upper surface of base plate 10 faces generally upwardly e.g. generally toward the rest of the assemblage of force transmission device 8, and the lower surface of base plate 10 faces generally downwardly, e.g. generally away from the rest of the assemblage of force transmission device 8, toward a mounting substrate.

The first and second lateral portions of base plate 10 extend along the length of base plate 10, and each have an inner edge and an outer edge. A plurality of through bores 9 extends through each of the first and second lateral portions, between their respective inner and outer edges. Each through bore is adapted and configured to receive mounting hardware therethough which enables force transmission device 8 to be mounted to e.g. a suitable mounting substrate.

The medial portion of base plate 10 extends along the length of base plate 10 and provides, in the illustrated embodiment, a generally planar surface. The medial portion of base plate 10 lies generally between, and is generally parallel to and generally above e.g. not coplanar with, the first and second lateral portions of base plate 10.

First and second elongate projections 21 of base plate 10 extend along the length of base plate 10 and upwardly away from, as well as generally perpendicular to, the first and second lateral portions 12A, 12B, respectively. The first and second elongate projections communicate with the inner edges of lateral portions 12A, 12B and the outer edges of medial portion 13, whereby the first lateral projection connects to the first lateral portion and the medial portion, and the second lateral projection connects to the second lateral portion and medial portion.

Accordingly, the first and second lateral portions 12A, 12B, the elongate projections 21, and the medial portion 13 of base plate 10, in combination, provide mounting surfaces/structures in two distinct yet generally complementary surfaces and enable the remaining assemblage of force transmission device 10 to be mounted to base plate 10 and base plate 10 to be mounted, in turn, to e.g. a suitable mounting substrate via bores 9.

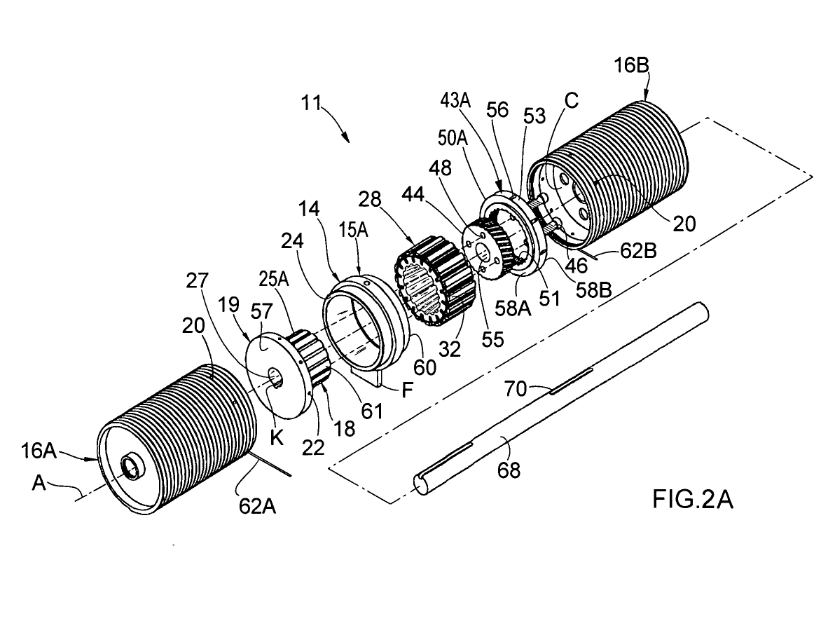

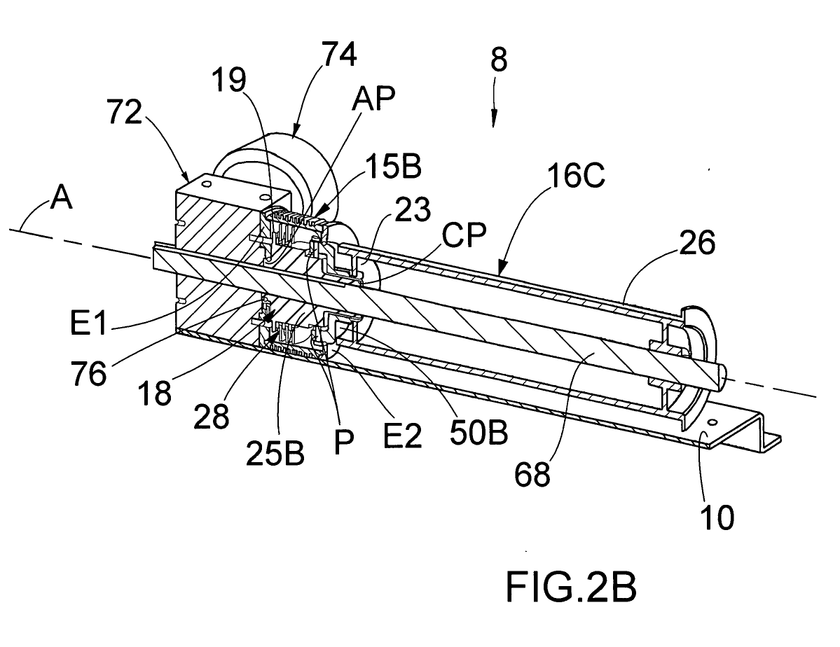

Referring now to FIGS. 1A and 1B, winding assembly 11 includes clutch/brake assembly 14 which will be described in greater detail hereinafter, winding drums 16A, 16B and/or 16C (FIGS. 1B, 2B), and defines an outer surface. Winding assembly 11 is adapted and configured to function as a clutch and/or a brake, the outer surface of winding assembly 11 corresponds to the outer surfaces of at least one of clutch/brake assembly 14, and winding drums 16A, 16B and/or 16C.

Clutch/brake assembly 14 includes a clutch and/or brake housing, e.g. fixed housing 15A (FIG. 2A). Flange “F” is an elongate projection or “mounting tab” extending downwardly from fixed housing 15A. In clutch/brake assembly 14, flange “F” is fixedly attached to base plate 10, as well as to housing 15A, thereby generally fixing parts of clutch/brake assembly 14 to base plate 10. Namely, the fixed attachment of flange “F” to base plate 10 ensures that housing 15A (FIG. 2A) does not rotate relative to base plate 10. Those skilled in the art are well aware of attachment means suitable to attach flange “F” to base plate 10 including but not limited to welding, riveting, bolting, and/or other known attachment means suitable to attach components of clutch/brake assembly 14 to the base plate 10.

Winding drums 16A, 16B, and/or 16C (FIGS. 1A, 1B, 2B) rotatably communicate with, and are generally coaxial with, clutch/brake assembly 14. Each of winding drums 16A, 16B, and/or 16C (FIGS. 1A, 1B, 2B) has first and second generally circular end walls 23, and a length dimension defined therebetween. Each winding drum is adapted and configured to rotate about an axis of rotation, e.g. axis of rotation “A.”

Outer circumferential wall 26 extends generally along the length dimension of winding assembly 11, extends circumferentially around axis of rotation “A,” and has surface characteristics, such as, but not limited to, a helical guide groove which is formed into the outer surface of the outer circumferential wall, extends helically circumferentially around the outer surface of the outer circumferential wall, and defines a concave groove perimeter having a generally uniform groove radius. The surface characteristics of the outer circumferential wall define a cooperating relationship with surface characteristics of corresponding parts of force transmission device 8, e.g. cables 62A, 62B. First and second generally circular end walls 23, and outer circumferential wall 26 of winding drums 16A, 16B, and/or 16C, in combination, define a generally cylindrical assemblage of winding assembly 11.

Winding assembly 11 rotatably communicates with, and is generally coaxial with, bearing assembly 17 which includes a bearing housing which has a generally arcuate projection, a mounting flange, and at least one bearing. The generally arcuate projection of bearing assembly 17 has a thickness dimension and a bore which defines an opening bore diameter and extends into and/or entirely through the generally arcuate projection, e.g. at least partially along the thickness dimension of the generally arcuate projection of bearing assembly 17.

Each of the bearings of bearing assembly 17 has an outer race diameter which corresponds in magnitude to the magnitude of the opening bore diameter, and an inner race diameter, defined by an inner race bore which extends generally through the bearing. The relationship between the magnitudes of bearing outer race diameter and the opening bore diameter of the generally arcuate projection enables the bearing to be slidingly received, and/or press fit, into the generally arcuate projection of bearing assembly 17.

Cables 62A, 62B are generally flexible and elongate and have generally uniform diameters and radii. The outer surfaces of cables 62A, 62B define arcs which generally correspond to the arcuate shapes of the concave helical guide grooves formed in the outer circumferential surfaces of the respective winding drums 16A, 16B, 16C whereby cables 62A, 62B are adapted and configured to be windingly received by the helical guide grooves of respective ones of drums 16A, 16B, 16C. Cables 62A, 62B comprehend any of the variety of cable, wire, wire rope, and/or rope materials commonly known/used in the lifting/lowering industry, including but not limited to e.g. multi-strand wound steel cable, woven steel cable, and/or others.

Each of sheaves “S” is generally circular and/or cylindrical. Each sheave “S” has first and second generally circular ends, and a circumferential outer surface which is adapted and configured to rotatably receive, for example, cable 62A and/or 62B thereupon. Sheave “S” acts as e.g. a pulley which may be adapted and configured to rotate about an axis of rotation, by a distance which corresponds to a length of cable 62A and/or 62B which communicates with, and travels across, the outer circumferential surface of sheave “S.”

Cables 62A, 62B are attached to, optionally removably attached to, load 66 which can include any of a variety of structures/objects having mass. Such structures/objects include but are not limited to structures/objects which are desirable to lift/lower between a first, relatively higher position and a second, relatively lower position, e.g. elevator cars, dumb waiters, window washer platforms, construction/building material hoisting platforms, etc.

Gearbox 72 includes a gearbox housing, a gear assembly, an input shaft, and an output shaft. Gearbox 72 is in driving communication with winding assembly 11 and is attached to, e.g. generally fixedly secured to, base plate 10. The input and output shafts of gearbox 72 are respectively in driving communication with, and driven communication with, the gear assembly of gearbox 72. The gear assembly of gearbox 72 is adapted and configured to convert and/or transmit at least one of a direction of torque, a magnitude of torque, and a speed of rotation realized by the input shaft of gearbox 72 into a corresponding, but not necessarily equal, direction of torque, magnitude of torque, and/or speed of rotation realized by the output shaft of gearbox 72 which enables force transmission device 8 to lift/lower load 66 at a desirable rate of speed/distance of travel.

Those skilled in the art are well aware of gear assemblies which are suitable to convert and/or transmit at least one of a direction of torque, a magnitude of torque, and a speed of rotation realized by the input shaft of gearbox 72 into a corresponding, but not necessarily equal, direction of torque, magnitude of torque, and/or speed of rotation realized by the output shaft of gearbox 72 which enables force transmission device 8 to lift/lower load 66 at a desirable rate of speed/distance of travel. Such suitable gear assemblies include but are not limited to worm gear assemblies, spur gear assemblies, helical gear assemblies, crossed helical gear assemblies, bevel gear assemblies, spiral bevel gear assemblies, ring and pinion assemblies, planetary gear assemblies, and others.

Motor 74 is an AC or DC electric motor and optionally a single-phase AC or DC electric motor, which includes a motor output shaft in driving communication with the input shaft of gearbox 72 and optionally comprises the input shaft of gearbox 72 in its entirety. Motor 74 realizes a working speed and working torque sufficiently great in magnitude to suitably rotate the input shaft of gearbox 72, the gears of gearbox 72, and the output shaft of gearbox 72 so as to lift and/or lower load 66 as desired, e.g. at a desired rate of travel, while still proving relatively economical to operate in terms of power consumption, maintenance, and other operating costs.

Conventional mounting hardware such as bolts, screws, and/or other suitable types of conventional mounting hardware, extend through each of the plurality of through bores 9 which extend through each of the first and second lateral portions 12A, 12B of base plate 10 and thereby attach base plate 10 to the suitable and/or desirable mounting substrate which can be a wall, a ceiling, a floor, a gantry crane, or other suitable mounting substrates. In addition, conventional mounting hardware attaches piece-parts and/or subassemblies of force transmission device 8, including but not limited to ones of bearing assembly 17, gearbox 72, and motor 74, to base plate 10 thereby mounting force transmission device 8 in its entirety to such suitable substrate.

Flange “F” of clutch/brake assembly 14 and the mounting flange of bearing assembly 17 are each attached to base plate 10 along the length of base plate 10 and at locations distinct from, and typically coplanar with, each other.

Typically, of the clutch/brake assembly 14, winding drums 16A, 16B, and the bearing and/or bearings of bearing assembly 17 are generally concentric, and coaxial with respect to the axis of rotation “A.” Accordingly, ones of the clutch/brake assembly 14, winding drums 16A, 16B, and the bearing and/or bearings of bearing assembly 17 are generally coaxial with other ones of the clutch/brake assembly 14, winding drums 16A, 16B, and the bearing and/or bearings of bearing assembly 17. And the length of each of the clutch/brake assembly, the winding drums, and the bearing and/or bearings is each generally perpendicular to the direction which cables 62A, 62B extend away from winding drums 16A, 16B.

Sheaves “S” are positioned and/or installed where desired so as to enable a rotational movement of winding drums 16A, 16B to be converted to e.g. generally vertically actuated linear movement of load 66. Those skilled in the art are well aware of suitable methods of mounting, suitable hardware for mounting with, suitable substrates to mount to, and suitable positional orientations in which to mount, sheaves “S” relative to force transmission device 8 and load 66 to facilitate lifting/lowering load 66 in a desired manner.

Referring now to FIG. 2A, winding assembly 11 includes clutch/brake assembly 14, winding drums 16A, 16B, and drive core 18. Clutch/brake assembly 14 includes housing 15A, disc pack assembly 28, and force converter 43A.

Housing 15A is generally cylindrical, has a first outer facing surface 24 which faces a first direction, and a second outer facing surface 60 which faces a second, opposite direction, and a bore which extends therethrough, from first outer facing surface 24 to second outer facing surface 60, and defines an inner surface of housing 15A. Housing 15A further includes an outer circumferential surface which extends circumferentially between first outer facing surface 24 and second outer facing surface 60 and has an elongate projection, e.g. flange “F” which is adapted and configured to interface with base plate 10, and which extends downwardly from outer facing surface 24.

Disc pack 28 includes a plurality of discs, the assemblage of which is generally cylindrical, and which generally defines an outer circumferential surface. Disc pack 28 has a length and a through bore which extends along the length of disc pack 28 and is generally coaxial with the outer circumferential surface of disc pack 28.

Force converter 43A includes, as first and second actuation members, helical gear 44 and pressure plate 50A, respectively. Helical gear 44 is generally cylindrical, has first and second generally circular ends which define a length dimension of the gear therebetween, an outer circumferential surface which has at least one helical spline element, e.g. a helical/diagonal projection extending therefrom and/or a helical/diagonal groove, extending thereinto.

A through bore 55 extends from approximately the middle of one of the first and second generally circular ends to approximately the middle of the other one of the first and second generally circular ends of helical gear 44, e.g. extends generally medially through the middle of helical gear 44 along the entire length of helical gear 44.

A plurality of apertures 48 extend through helical gear 44. Each aperture 48 extends through helical gear 44 generally parallel to through bore 55, and is disposed between the through bore and the outer circumferential surface of gear 44, and is spaced from other ones of apertures 48.

Pressure plate 50A is generally cylindrical, has first and second generally circular ends which define housing facing end surface 58A and winding drum facing end surface 58B. End surfaces 58A, 58B define a thickness dimension therebetween. Pressure plate 58 further defines an outer circumferential surface 53 which has at least one aperture 56 which extends thereinto. Apertures 56 extend from the outer circumferential surface 53 radially inwardly toward the axis of rotation of pressure plate 50A. A generally cylindrical opening extends through pressure plate 50A, between end surfaces 58A, 58B, and defines inner perimeter surface 51, which is adapted and configured to cooperate with the outer surface of helical gear 44, whereby to enable combined rotational and axial sliding communication between helical gear 44 and pressure plate 50A.

Winding drums 16A, 16B are each substantially cylindrical, have first and second terminal ends, and an outer circumferential surface which has at least one aperture 20 extending therethrough. At least one of the first and second terminal ends of each of winding drums 16A, 16B defines a cavity “C,” which each of apertures 20 extend into, and which are adapted and configured to receive parts of other components of winding assembly 11 therein, e.g. adapted and configured to receive parts of drive core 18 and/or pressure plate 50A therein.

Drive core 18 comprises flange 19 which has a first generally flat and circular end surface 57 and an outer circumferential surface which defines a first, relatively larger diameter. Drive core 18 further comprises drive hub 25A, which has a second generally flat and circular end surface 59 and an outer circumferential surface 61 which defines a second, relatively smaller diameter. The generally flat and circular end surfaces 57, 59 of flange 19 and drive hub 25A face generally opposing directions, relative to each other. At least one aperture 22 extends inwardly from the outer circumferential surface of flange 19 toward the axis of rotation of flange 19.

The outer circumferential surface of drive hub 25A has a plurality of interfacing structures, such as splines, extending therefrom or thereinto. An opening 27 extends longitudinally through the center of and along the length of, drive core 18, generally defining an inner perimeter surface. The generally flat and circular end surface of drive hub 25A has a plurality of threaded bores extending thereinto, generally parallel to opening 27 and each being disposed between opening 27 and outer circumferential surface 61, which threaded bores are adapted and configured to correspond to and are aligned with apertures 48 which extend through helical gear 44, in the assembled device.

The inner perimeter surface defined by opening 27 includes a keyway “K” which extends, as is a slot along a part of the length of drive core 18. Drive hub 25A of drive core 18 extends through and is rotatably housed in housing 15A.

Elongate drive shaft 68 has a length, and a generally cylindrical outer surface. The outer circumferential surface of drive shaft 68 further has at least one keyway, e.g. slot 70 extending along at least a part of the length of shaft 68.

Drive shaft 68 extends medially through respective components of winding assembly 11 and is disposed radially inwardly with respect to disc pack assembly 28, housing 15A, gears 44, 50A, and winding drums 16A, 16B, and 16C (FIGS. 1B, 2A, 2B). Referring now to FIG. 2A, the outer diameter of drive shaft 68 corresponds generally to the inner diameter of the opening which extends through drive core 18. Keyway “K” of drive core 18 and slot 70 of shaft 68 are generally aligned with each other and interface with each other and with a key 64. Keyway “K,” slot 70, and key 64 are cooperatively sized and configured such that when the key is disposed in the aligned keyway and slot, a driving connection is realized between the shaft and the drive core. Accordingly, slot 70 of drive shaft 68, along with corresponding hardware such as keys, pins, or other conventional hardware, enable parts/components of force transmission device 8 to communicate with and/or drivingly engage other parts/components of force transmission device 8, such as e.g. to realize a driving connection between gearbox 72 (FIG. 1A) and drive core 18.

A first cable-receiving winding drum 16A is mounted over the outer surface of flange 19 of drive core 18. Namely, flange 19 is housed in cavity “C” of winding drum 16A. Winding drum 16A is secured to flange 19 by screws which extend through apertures 20 which extend radially inwardly from the outer circumferential surface of winding drum 16A, and into aligned apertures 22 in the outer circumferential surface of flange 19, whereby winding drum 16 and flange 19 are secured to each other so as to necessarily rotate together.

Drive core 18 rides/rotates against outer facing surface 24 of fixed housing 15A at flange 19 and drive hub 25A of drive core 18 projects into the fixed housing 15A when the device is fully assembled, so that drive hub 25A and housing 15A are generally coaxially aligned, and with housing 15A being generally concentrically outward of drive hub 25A.

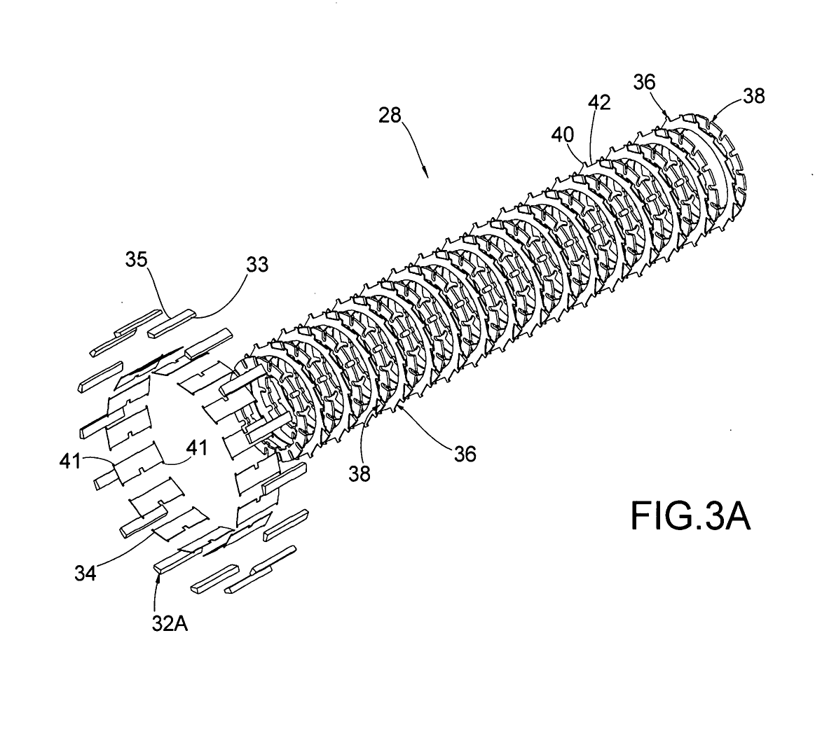

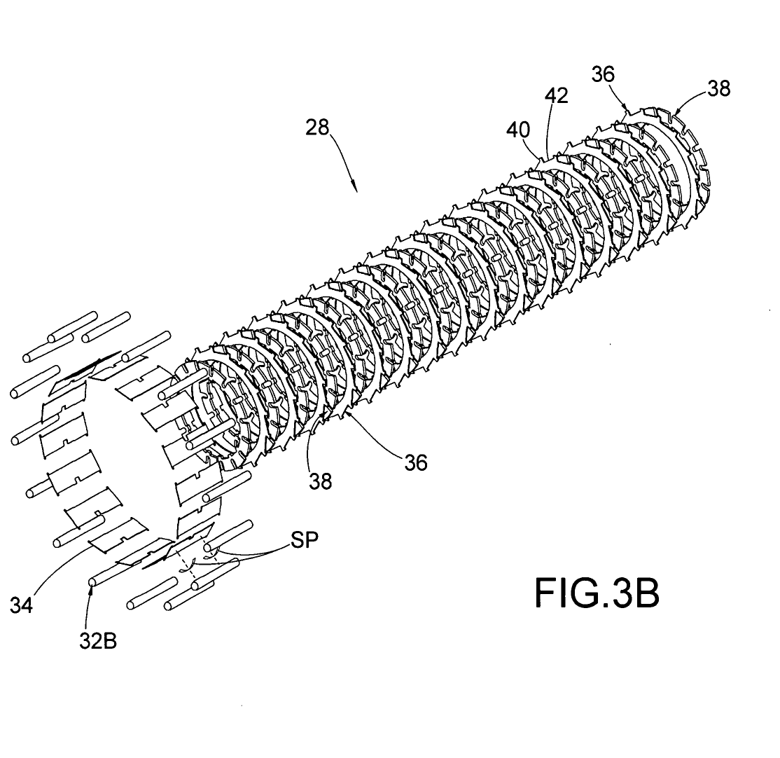

The outer splined surface of drive hub 25A engages with disc pack 28 through an interfacing relationship between the outer splined surface of drive hub 25A and the surface characteristics of the through bore which extends through the assemblage of disc pack 28, e.g. with friction discs 38 (FIGS. 3A, 3B) which will be described in greater detail hereinafter.

One of the first and second generally circular ends of helical gear 44 interfaces the correspondingly facing and generally flat and circular end surface of drive hub 25A, and apertures 48 which extend through helical gear 44 are generally in coaxial alignment with the threaded bores which extend into the generally flat and circular end of drive hub 25A. Bolts 46 extend through apertures 48 and threadedly into the threaded bores of drive hub 25A whereby to realize a mechanical mounting of drive hub 25A to helical gear 44, e.g. to mechanically mount drive core 18 to helical gear 44. With gear 44 and drive core 18 so mounted to each other through housing 15A, disc pack 28 is disposed inside housing 15A and drive hub 25A is disposed inside the central opening in disc pack 28.

Pressure plate 50A and helical gear 44 are in actuating communication with each other, when assembled, as enabled by the cooperating surface characteristics of the inner perimeter surface 51 of pressure plate 50A and the outer circumferential surface of helical gear 44. As one non-limiting example, the inner perimeter surface 51 includes a plurality of inwardly facing helical teeth whereby pressure plate 50A is an annular helical ring gear with an inner helically toothed surface adapted and configured to cooperate with the outer toothed circumferential surface of helical gear 44. The cooperating relationship between pressure plate 50A and helical gear 44 provides means for combined rotational and axial sliding communication between helical gear 44 and pressure plate 50A realized by the cooperating relationship between e.g. the inwardly facing helical teeth on the inner perimeter surface 51 of pressure plate 50A and the outwardly facing helical teeth of helical gear 44.

Pressure plate 50A is mounted to, and inwardly of part of, cable-receiving winding drum 16B. Namely, pressure plate 50A is received in cavity “C” of winding drum 16B. Screws and/or other conventional hardware (not shown) extend through apertures 20 which extend through the outer circumferential surface of winding drum 16B, and into corresponding aligned apertures 56 in outer circumferential surface 53 of pressure plate 50A, whereby pressure plate 50A is drivingly coupled to winding drum 16B for common rotation therewith. In the assembled mechanism, housing facing end surface 58A of pressure plate 50A is in generally surface-to-surface contact with end surface 60 of fixed housing 15A.

Referring to FIGS. 2A, 3A, and 3B, disc pack assembly 28 is slidably received on drive core 18 and rotatably received within fixed housing 15A. Disc pack assembly 28 comprises clutch discs 36 which have relatively larger diameters defined by inner and outer perimeters, friction discs 38 which have relatively smaller diameters defined by inner and outer perimeters, a plurality of braking elements 32A, 32B, and a plurality of interfacing plates 34.

Disc pack assembly 28 generally defines an axis of rotation, and a length, and comprises a sequential alternate stacking of clutch discs 36, and friction discs 38, mounted concentrically inside housing 15A and concentrically outside of opening 27 and drive hub 25A. The outer extremities of the outer perimeters of clutch discs 36 approximate the diameter of the inner surface of fixed housing 15A, with suitable clearance to allow for rotation of the clutch discs 36 with respect to, and inside the inner surface of, fixed housing 15A.

Referring now to FIGS. 3A, 3B, each clutch disc 36 is generally flat and circular, and has an inner perimeter surface which defines an opening formed therethrough. The outer perimeter of each clutch disc 36 is generally serrated, defining a plurality of regularly-spaced projections, e.g. teeth 40, and plate lands e.g. lands 42 located between respective ones of the teeth. Each land 42 defines first and second terminal ends and a surface which extends therebetween in a generally straight line, optionally with relatively shallow curvature.

The surface of a given land, which extends between the first and second terminal ends of the land, is disposed at an angle with respect to the tangent to the maximum outer diameter of the clutch disc 36, namely the diameter of an e.g. circle which touches the outer extremities of the respective teeth 40. Accordingly, each land 42 is disposed at an angle to the tangent of the outer perimeter of the clutch disc/plate, where the outer perimeter is defined at the extremities of the respective teeth.

Each friction disc 38 is generally flat and circular and has e.g. a maximum outer diameter generally smaller than the maximum outer diameter of clutch disc 36. Friction disc 38 has an inner perimeter surface, which defines an opening formed through the friction disc. The inner perimeter surface of friction disc 38 has projections/splines, which correspond to respective splines of drive hub 25A of drive core 18. In the assemblage of disc pack assembly 28, the inner perimeter surfaces of friction discs 38, in combination, define a through bore which extends through disc pack assembly 28. The through bore defined by the friction discs has surface characteristics which correspond with, and are adapted and configured to cooperate with, the outer circumferential surface of drive hub 25A.

Referring now to FIG. 3A, each braking element 32A has a length, which generally corresponds to the length of disc pack assembly 28. Each braking element 32A has a frontwardly facing edge 33 and a rearwardly facing edge 35. The rearwardly facing edge 35 of a corresponding braking element 32A has a first, relatively greater height, as measured generally along the radius of disc pack assembly 28, and the frontwardly facing edge has a second, relatively lesser height as measured generally along the radius of disc pack assembly 28. Accordingly, each braking element is generally tapered toward the frontwardly facing edge 33, from the first relatively greater height at the rearwardly facing edge to the second, relatively lesser height at the frontwardly facing edge.

Referring now to FIG. 3B, in another set of embodiments, disc pack assembly 28 includes braking elements 32B which are each substantially cylindrical columns, e.g. rollers, and each defines a diameter and a length.

The cross-section, e.g. diameter of each cylindrical braking element 32B is substantially consistent along the entire length of the respective braking element 32B. T cross-section of a given braking element 32B is smaller than the distance between the inner surface of housing 15A, 15B and the lowest point of land 42 of a clutch disc 36, e.g. the point on land 42 which is most distal from the inner surface of housing 15A, 15B. Further, the cross-section of a given braking element 32B is greater than the distance between the inner surface of housing 15A, 15B and the highest point of land 42 of a clutch disc 36, e.g. the point on land 42 which is closest to the inner surface of housing 15A, 15B.

The length of each cylindrical braking element 32B corresponds generally to the length of disc pack assembly 28. In some embodiments, the lengths of braking elements 32B are equal to at least the distance between the two clutch discs 36 which are spaced furthest from each other, so that braking element 32B can effectively engage and lock all of the clutch discs 36 in disc pack 28 in rotational unison.

Referring now to FIGS. 3A, and 3B, each of interfacing plates 34 has a length, which corresponds generally to the length of disc pack assembly 28. Interfacing plate 34 has an upper surface and a lower surface. In the illustrated embodiments, both the upper surface and the lower surface of interfacing plate 34 are generally planar or optionally define shallow, gentle curvatures. In the embodiments illustrated, the upper surface and lower surfaces of interfacing plates 34 are generally parallel to each other so as to define a generally uniform thickness of a given plate 34.

Friction discs 38 have relatively smaller inner and outer perimeters as compared to clutch discs 36, when considering the average radius along the inner perimeter and the average radius along the outer perimeter. The inner perimeter surface of each of friction disc 38 is adapted and configured to engage the splined surface of drive hub 25A of drive core 18. Because friction discs 38 are mounted by a spline configuration to drive core 18, the friction discs, in general, rotate independently of any rotation of clutch discs 36, except for any friction which may be applied between friction discs 38 and clutch discs 36 at interfacing areas of their surfaces.

Interfacing plates 34 lie against, and are supported on, lands 42, in orientations which are generally perpendicular to clutch discs 36. The width of a given interfacing plate extends substantially the full length of a respective land 42 between respective ones of the teeth. The teeth 40 on clutch discs 36 are collectively aligned with each other along the length of disc pack assembly 28 whereby the corresponding lands 42 are also aligned with each other. A given line of lands, extending in the direction of axis “A” thus defines a receiving bed which extends generally the full length of the disc pack assembly. A given interfacing plate has a length which extends over all of the lands underlying a given receiving bed, with sufficient additional length to support locating tabs 41 which bear against the outer surface of the outermost clutch discs 36 on opposing ends of the disc pack assembly. Tabs 41 thus lock a given interfacing plate 34 against longitudinal movement of the interfacing plate relative to the clutch discs.

The width of an interfacing plate corresponds to the width of a respective receiving bed at lands 42. Accordingly, with the interfacing plate in a receiving bed, and extending along the length of the disc pack assembly, e.g. generally parallel to axis “A,” and extending generally between respective ones of the teeth, the interfacing plate prevents the clutch discs from rotating with respect to each other. As a result, the interfacing plates 34, one at each land about the circumferences of the respective clutch discs 36, rotatably lock clutch discs 36 together for common rotation, such that all of clutch discs 36 rotate in unison.

In the completed assemblage of disc pack assembly 28, braking elements 32A, 32B extend lengthwise of fixed housing 15A, as do the interfacing plates 34, and thus are axially aligned with the axis of rotation of the clutch discs 36; and the lengths of the braking elements extend parallel with the interfacing plates with the braking elements thus being positioned between fixed housing 15A and respective ones of the interfacing plates. In some embodiments, braking elements 32A are elongate wedges, which define arcuate wedge angles corresponding generally to the angles between the lands 42 of the clutch discs 36 and tangents to circles which are coaxial with the maximum radii of the clutch discs 36. The braking elements fit loosely, but rather snug, between the interfacing plates on lands 42, and the inner surface of fixed housing 15A.

Lands 42 of the clutch discs 36, through interfacing plates 34, hold the outer surfaces of the braking elements in surface-to-surface alignment with the inner surface of fixed housing 15A. Because all of the lands 42 define the same angle with the tangent to the maximum radii of the clutch discs 36, which define circumferences which are concentric with the inner surface of the fixed housing, when the clutch is rotated in a first direction, the braking elements 32A, 32B are urged by the fixed angles of the interfacing plates and lands 42, in a wedging action, against the inner surface of the fixed housing, causing a braking action. When the clutch is rotated in the opposite direction, the angles of lands 42 and interfacing plates 34 do not urge the braking elements 32A, 32B against the inner surface of the fixed housing, whereby the clutch offers generally no friction resistance to rotation of drive shaft 68.

In other embodiments, not shown, interfacing plates 34 are omitted. In such embodiments, braking elements 32A, 32B take on the additional role of preventing rotation of the cutch discs relative to each other. Considering the necessity for the braking elements to move in the receiving beds to perform the braking function, in such embodiments where the braking elements are used to prevent rotation of clutch discs 36 relative to each other, some limited rotation of the clutch discs relative to each other is experienced. However, such is limited to rotation of about the distance between teeth on a clutch disc.

Referring now to FIG. 3B, in the illustrated embodiments, disc pack assembly 28 includes a plurality of springs “SP” which are generally arcuate and are adapted and configured to biasingly urge braking elements 32A, 32B outwardly toward/against housing 15A, 15B. Namely, springs “SP” are leaf-type springs which can be made from, for example, relatively flat and elongate pieces of spring steel, other spring-type materials, and/or other materials which can suitably biasingly urge braking elements 32A, 32B outwardly toward/against housing 15A, 15B.

Each of springs “SP” has first and second terminal ends and a medial portion therebetween. The medial portion of spring “SP” curves generally outwardly between the first and second terminal ends and is thus positioned generally radially outwardly from the first and second terminal ends.

The first and second terminal ends of springs “SP” communicate with interfacing plate 34 and the medial portions of springs “SP” communicates with braking element 32B. Accordingly, springs “SP” provide a biasing force between the interfacing plate 34 and braking elements 32B which enables braking elements 32A, 32B to biasingly urge outwardly toward/against housing 15A, 15B.

Referring now to FIGS. 1A, 2A, 3A, and 3B, in use, a left cable 62A is wound about the outer surface of left winding drum 16A and a right cable 62B is wound about the outer surface of right winding drum 16B. As illustrated in FIG. 1A, cables 62A and 62B extend from the winding drums to load 66, such as an elevator car.

Weight of load 66 which passes through cable 62A, passes through winding drum 16A through the screws holding the winding drum to flange 19 of drive core 18, and from drive core 18 to drive shaft 68 through the combination of keyway “K,” a suitable key (not illustrated), and slot 70, thus to drive shaft 68. Drive shaft 68 is connected to gear box 72, thence to the electric drive motor 74 which lifts and lowers load 66.

The weight of load 66, which passes through cable 62B, passes through winding drum 16B and from winding drum 16B through the screws which hold winding drum 16B to pressure plate 50A. The weight force passes from pressure plate 50A, by way of the inwardly disposed spline teeth of pressure plate 50A, and interfaces with the outwardly disposed spline teeth of helical gear 44, thereby to exert rotational torque on gear 44 and correspondingly on driving core 18. Since gear 44 and drive core 18 rotate in common with shaft 68, since shaft 68 rotates only in common with gearbox 72 and motor 74, the force applied to gear 44 by load 66 through cable 62B, thence through pressure plate 50A, is resisted by gear 44. Pressure plate 50A thus rotationally actuates, and axially actuates (as dictated by the helical interfacing structures of helical gear 44 and pressure plate 50A) whereby pressure plate 50A interfaces with, and applies an axial force to, disc pack assembly 28. As the axial force is applied to disc pack assembly 28, the alternatingly stacked clutch discs 36 and friction discs 38 are urged closer to each other, which correspondingly increases the frictional engagement between clutch discs 36 and friction discs 38.

The direction of rotation of the winding drums is selected in combination with the directional pitch of the helical gear 44 and the pressure plate 50A so that the weight of load 66, in combination with any resistance applied through shaft 68, results in pressure plate 50A applying an axial force on the disc pack assembly by way of clutch discs 36 and friction discs 38. The axial force which frictionally engages-clutch discs 36 and friction discs 38 is related to, typically is proportional to, the magnitude of the weight of load 66 as transmitted through cable 62B.

Accordingly, the greater the weight of load 66, the greater the axial force which is exerted by pressure plate 50A and correspondingly applied by the combination of helical gear 44 and pressure plate 50A to the stack of clutch discs 36 and friction discs 38. While load 66 is applying an axial force on the clutch discs 36 and friction discs 38 through helical gear 44, load 66 is simultaneously applying a rotational force to drive shaft 68, through drive core 18. However, braking elements 32A, 32B, as appropriate, are oriented, by virtue of lands 42, to constantly resist rotation of the winding drums in the direction of downward movement of load 66.

Accordingly, the rotational force applied by the weight of load 66 tends to cause rotation of the drive shaft 68 thus to lower load 66, which requires rotation of the friction discs 38 against the resistance of braking elements 32A, 32B as applied at the inner surface of fixed housing 15A. Namely, any rotation of clutch discs 36 drives braking elements 32A or 32B toward the inner surface of housing 15A, causing frictional engagement of the braking elements against the inner surface of housing 15A. This frictional engagement of the braking elements against the inner surface of housing 15A resists rotation of clutch discs 36 with respect to fixed housing 15A in the direction of downward movement of load 66. Thus, braking elements 32A, 32B provide a mechanical load compensation by introducing a braking function to resist rotation of the winding drum, in the absence of driving force from the drive motor. The magnitude of the braking friction is designed such that the magnitude of the braking force is always greater than the magnitude of the rotational force exerted by load 66 at drum 16A and/or 16B.

The cooperating spline angles on helical gear 44 and pressure plate 50A are so selected that the downward rotational urge of the weight of load 66 on drive shaft 68 is always countered by enough axial loading of the clutch discs 36 and the friction discs 38 to prevent frictional sliding of the friction discs 38 with respect to the clutch discs 36 under the gravitational weight of load 66.

Namely, the spline angle, in combination with the net friction between discs 36 and 38, is such that any change in operating magnitude of load 66 is accompanied by a corresponding change in the magnitude of the axial force, sufficient to prevent downward movement of the load based on gravity forces alone. Since the clutch discs 36 are prevented from rotating by braking elements 32A, 32B, and since the winding drums can rotate a substantive distance only when friction discs 38 rotate, disc pack assembly 28 effectively prevents rotation of the winding drums when shaft 68 is not powered by motor 74.

Thus, in a static situation, load 66 is automatically held at whatever is its elevation by the braking action of disc pack assembly 28, including through braking elements 32A, 32B. Indeed, the braking action of braking elements 32A, 32B is being applied under all conditions of load except when the load is being lifted.

As mass, and thus weight, is added to or subtracted from the load, the resulting increase or decrease in weight passes through cable 62B and provides a generally proportional increase or decrease in the axial loading on the discs 36, 38 thereby linearly increasing and/or decreasing the force with which the discs 36, 38 are coupled to/interface with, each other by frictional engagement. In addition, the increase or decrease in load provides a generally proportional increase or decrease in the rotational force which is applied to shaft 68 through gear 44 and drive core 18, and whereby any incremental movement of clutch discs 36 causes corresponding movement of brake elements 32A, 32B along lands 42, thus to increase or decrease the braking force between brake elements 32A, 32B and housing 15A.

When load 66 is to be lowered, drive shaft 68 is powered by motor 74 and gear box 72 with sufficient force to overcome the existing frictional braking action of braking elements 32A, 32B against the inner surface of fixed housing 15A. That existing braking friction is sufficient in magnitude to prevent gravitational movement of the load, sufficient to support load 66 under static conditions. The existing braking friction between braking elements 32A, 32B and housing 15A remains in place and active while load 66 is being lowered. Correspondingly, the act of lowering the load requires that a driving force be applied to shaft 68 in the rotational direction of the shaft required for downward movement of the load. Thus, where downward movement of the load requires counterclockwise rotation of shaft 68, then an active driving force must be applied by gear box 72, driving shaft 68 in the counterclockwise direction to effect lowering of the load. Such driving of shaft 6 in lowering the load is resisted by an opposite direction resistance being applied by brake elements 32A or 32B. Thus, the net affect of brake elements 32A, 32B is to substantially transfer the effect of the weight of the load to brake elements 32A, 32B and housing 15A, rather than to shaft 68. As a result, the magnitude of the drive-through force required for lowering load 66 is predominately a function of the magnitude of the braking force being applied at brake elements 32A, 32B, rather than being predominately a function of the magnitude of load 66. Any time a downward driving force is withdrawn from shaft 68, the in-effect braking friction between braking elements 32A, 32B and fixed housing 15A takes over and controls the load, holding the load at the elevation whereat the downward driving force was withdrawn. Accordingly, the braking force is always in place in the downward direction of movement of the load, and when the load is stationary, and controls/holds load 66 stationary any time the downward driving force of drive shaft 68 is withdrawn.

When load 66 is being lowered, the force required on the shaft 68, e.g. required shaft torque, is at least nominally greater than the force required on the shaft 68 to lift load 66 without any braking force in place. Such shaft torque is applied in part by the downward gravitational force of the load, and the balance of the shaft torque is applied by motor 74 through gear box 72. Accordingly, any time downward movement of the load is effected, a shaft torque input, in the direction of load lowering movement, is required from motor 74 to rotationally drive the shaft through the mechanical load compensation braking force which is applied by disc pack assembly 28.

When load 66 is to be lifted, the motor drives the gear box in a suitable direction, which drives drive shaft 68, in a lifting direction to lift load 66. Since lands 42 bias the braking elements only in the downward direction of movement of load 66, a lifting drive on shaft 68 releases the braking elements 32A, 23B from engagement with the inner surface of fixed housing 15A, namely moves lands 42 relative to braking elements 32A, 32B, thereby to release the braking elements, whereby the force required to lift load 66 approximates the free wheeling lifting force required of a drive system not having disc pack assembly 28.

In light of the above, it is clear that a positive driving force, in the rotational direction of shaft 68 whereby the load is lowered, is required to drive winding drums 16A, 16B when load 66 is to be moved in the downward direction. To move load 66 in the upward direction, a corresponding driving force, opposite in direction, is required at shaft 68.

The magnitude of the driving force required to lower the load depends on the magnitude of the braking force which resists lowering the load. Accordingly, the magnitude of the driving force required for lowering the load can be greater than, or less than, the driving force required to lift the load.

For example, where the load is e.g. 500 pounds, and a braking force sufficient to support 600 pounds is effected by brake elements 32A, 32B, then a positive driving force of only 100 pounds is required to drive the load downwardly.

Correspondingly, where the load is e.g. 500 pounds, and a braking force sufficient to support 1200 pounds is effected by brake elements 32A, 32B, then a positive driving force of 700 pounds is required to drive the load downwardly.

In the upward lift direction, the brake is automatically released by movement of lands 42 relative to brake elements 32A, 32B, and is automatically and immediately applied, again by movement of lands 42 relative to braking elements 32A, 32B, when any movement in the downward direction is initiated.

A nominal amount of rotation of clutch discs 36 in the downward direction is required to bring braking elements 32A, 32B into engagement with housing 15A by e.g. correspondingly urging braking elements 32A, 32B upwardly along lands 42 and into engagement with housing 15A. Given such nominal movement, in the downward direction, to engage braking elements after upward movement of the load, a nominal distance movement of the load may be effected, whereupon the braking is again in place, and the drive shaft 68 drives through that braking force in moving load 66 in the downward direction.

Accordingly, force transmission device 8 is adapted and configured to provide a passive braking function, when motor 74 is not energized, so as to resist an e.g. gravitational or other force applied to load 66 which tends to urge drums 16A, 16B to unwind cable 62A, 62B therefrom. Namely, force transmission device 8 is adapted and configured to hold load 66 at a constant height when motor 74 is not energized. Further, the force being applied to hold load 66 in a fixed location, when driving force is withdrawn from shaft 68, changes dynamically as the magnitude of load 66 changes. Also, force transmission device 8 is adapted and configured to actively drive through the passive braking force so as to drive load 66 generally downwardly.

The magnitude of the braking force applied by brake elements 32A, 32B and correspondingly the rotational force applied to shaft 68, by load 66, is largely controlled by the angle between the helical teeth on gear 44 and pressure plate 50A and the direction of extension of axis of rotation “A.” Thus, one can design gear 44 and pressure plate 50A to provide braking forces of any of a wide range of relationships to the gravitational force being applied by the load. Thus, the braking force can be only nominally greater than the load force; or the braking force can be greater than the load force by a ratio of 1.5/1; or 3/1; or 4.5/1; or any other desire ratio. The greater the ratio, the more secure the holding of the load, but the more the force needed for driving through the braking resistance when the load is to be lowered.

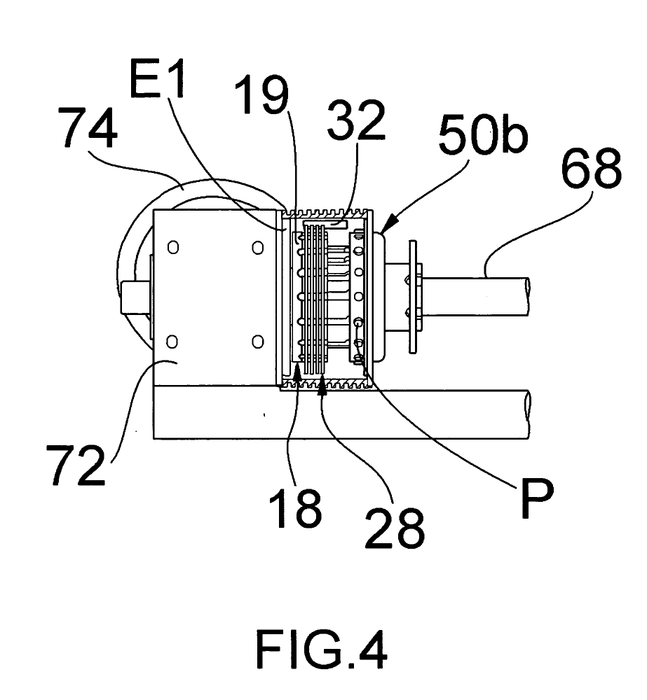

Referring now to FIGS. 1B and 2B, in some embodiments, force transmission device 8 utilizes winding assembly 11 which includes clutch/brake assembly 14 that communicates with and is located between, only one winding drum 16C, and gearbox 72. As shown in FIG. 1B, a force transmission device with one winding drum 16C can utilize two, alternatively more, cables 62A, 62B. When using one winding drum 16C and two cables 62A, 62B, both of cables 62A and 62B transfer the gravitational force applied by suspended load 66 onto drum 16C, resulting in mechanical load compensation via disc pack assembly 28 (FIGS. 2B, 3A, 3B, 4, and 5).

Referring now to FIG. 2B, clutch/brake assembly 14 includes (i) a clutch and/or brake housing, e.g. housing 15B, which is generally cylindrical, and which includes first and second outer end caps E1, E2, and an outer circumferential surface, and (ii) force converter 43B which includes parts of drive core 18 as a first actuation member, e.g. drive hub 25B, and a second actuation member, e.g. pressure plate 50B and pins “P.”

The outer circumferential surface of housing 15B includes a plurality of cooling elements, e.g. circumferential projections extending therefrom, and/or grooves extending thereinto, which relatively increases the surface area of the outer circumferential surface of 15B, as compared to a relatively planar outer circumferential surface. The cooling elements of housing 15B enable housing 15B to realize a relatively cooler operating temperature, as the relatively increased surface area can dissipate more heat than e.g. a relatively smoother circumferential surface.

End cap E1 of housing 15B is generally flat and circular, is adapted and configured to communicate with gearbox 72, has an inner circumferential surface generally defined by a through bore which extends generally medially therethrough, and a plurality of mounting apertures which extend therethrough, generally parallel to the through bore and between the through bore and the outer circumferential surface. The inner circumferential surface of end cap E1 includes receiving structure, such as but not limited to a groove, adapted and configured to receive/hold a seal e.g. an o-ring therein.

The mounting apertures which extend through end cap E1 correspond to mounting structure and/or apertures which extend through a sidewall of gearbox 72, enabling end cap E1 to be fixedly attached to such sidewall of gearbox 72 by e.g. conventional hardware. Thus, flange “F” is absent from housing 15B, because the attachment of housing 15B to gearbox 72 holds housing 15B in a fixed, non-rotatable position, the same as if housing 15B were attached to plate 10 through flange “F.”

End cap E2 of housing 15B is generally flat and circular, and is adapted and configured to communicate with pressure plate 50B. Namely, end cap E2 is adapted and configure to rotatably house at least a portion of pressure plate 50B therein. End cap E2 further includes a radially inner circumferential surface generally defined by a through bore which extends generally medially therethrough and which has receiving structure, such as but not limited to a groove, adapted and configured to receive/hold a seal e.g. an o-ring therein, which enables pressure plate 50B to rotate with respect to, and with a generally liquid tight relationship with, end cap E2.

Drive core 18 includes (i) flange 19 which has a generally flat and circular end surface and a generally annular projection AP extending medially therefrom, and (ii) drive hub 25B which has a length and an outer circumferential surface, and a generally flat and circular end surface with a generally cylindrical projection CP which extends medially therefrom and defines an outer circumferential surface. The annular projection AP and the cylindrical projection CP, of drive core 18, namely of flange 19 and hub 25B respectively, each face generally opposing directions relative to the other.

The generally annular projection AP of flange 19 includes an outer circumferential surface which has receiving structure, such as but not limited to a groove 76, adapted and configured to receive/hold a seal e.g. an o-ring therein. Such seal communicates with both of, and in between, the annular projection AP of flange 19 and the inner circumferential surface of end cap E1, which enables drive core 18 to rotate with respect to, and with a generally liquid tight relationship with, end cap E1 of housing 15B.

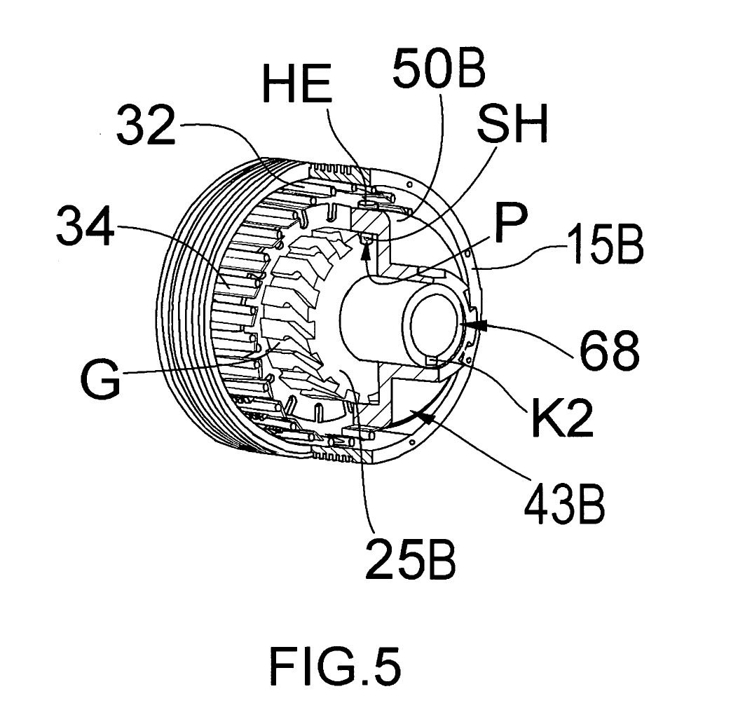

The outer circumferential surface of drive hub 25B is adapted and configured to interface with pressure plate 50B. Specifically, the outer circumferential surface of drive hub 25B has a plurality of interfacing structures, such as splines and corresponding grooves “G,” defined therein, which extend longitudinally less than the entire length of hub 25B. A first portion of a given spline or groove has a helical configuration or helical groove and extends to and opens into a corresponding non-helical portion of the groove “G,” thereby to define a multi-stage groove having a first, generally helical groove stage and a second, generally straight, or non-helical groove stage all as illustrated in FIG. 5.

Each of the annular projection AP, flange 19, hub 25B, and the cylindrical projection CP is in generally coaxial alignment with other ones of the annular projection AP, flange 19, hub 25B, and the cylindrical projection CP. An opening/bore extends medially through drive core 18, namely through the annular projection AP, flange 19, hub 25B, and the cylindrical projection CP and defines an inner perimeter having an inner perimeter surface which is adapted and configured to cooperate with surface characteristics of the outer circumferential surface of drive shaft 68, namely inner perimeter surface of the opening/bore which extends through drive core 18 has a keyway “K2” defined therein which is a slot extending at least partially along the length of drive core 18.

Referring still to FIG. 2B, keyway “K2” of drive core 18 and slot 70 of shaft 68 are generally aligned with each other and both interface with e.g. a key whereby to realize a driving connection therebetween. Accordingly, slot 70 of drive shaft 68, along with corresponding hardware such as keys, pins, or other conventional hardware, enable parts/components of force transmission device 8 to communicate with and/or drivingly engage other parts/components of force transmission device 8, such as e.g. to realize a driving connection between gearbox 72 (FIGS. 1B, 2B) and drive core 18.

Referring now to FIGS. 2B, 4, and 5, pressure plate 50B includes a first, relatively greater diameter portion having an outer circumferential surface having a plurality of apertures which extend therethrough, and a second, relatively lesser diameter portion having an outer circumferential surface.

The relatively greater diameter portion of pressure plate 50B defines a cavity formed therein whereby the greater diameter portion of pressure plate 50B defines e.g. a collar, and a cavity opening defined at a terminal end of the greater diameter portion of pressure plate 50B, which cavity opening provides access to the cavity. The cavity opening, and the cavity, of the greater diameter portion of pressure plate 50B are adapted and configured to slidably communicate with and extend over at least part of drive hub 25B. For example, pressure plate 50B can be adapted and configured to rotatably and/or axially advance and/or regress between (i) a first position in which pressure plate 50B covers, and/or extends over, a relatively lesser portion of the length of drive hub 25B and (ii) a second position in which pressure plate 50B covers, and/or extends over, a relatively greater portion of the length of drive hub 25B along axis of rotation “A.”

Interfacing plates 34, shown in FIG. 5, are received in receiving beds on lands 42, and extend between end ones of clutch plates 36. As in the earlier embodiments, interfacing plates 34 extend the full width of the lands 42 whereby plates 34 prevent substantial rotation of clutch plates 36 with respect to each other. As with the earlier embodiments, interfacing plates 34 can be omitted, whereupon limited clutch disc-to-clutch disc rotation is experienced, as discussed with respect to the previous embodiments.

Pins “P” are elongate relatively columnar structures, each having a shank “SH” which defines a shank diameter of a first, relatively lesser diameter and a head “HE” which defines a head diameter of a second, relatively greater diameter. The magnitude of the shank diameter corresponds in shape to, and is slightly less than, the magnitude of the opening defined by each of the plurality of apertures which extend through the relatively greater diameter portion of pressure plate 50B, while the magnitude of the head is greater than, the magnitude of the openings defined by the apertures which extend through the relatively greater diameter portion of pressure plate 50B.

Accordingly, each of pins “P” is adapted and configured to extend through the generally radially-extending apertures of the relatively greater diameter portion of pressure plate 50B to the extent permitted by the head of pin “P.” Thus, the shank of each pin “P” is housed in the respective radial aperture which extends through the relatively greater diameter portion of pressure plate 50B so that part of the shank protrudes into the cavity defined by pressure plate 50B and the head of pin “P” interfaces with outer circumferential surface of pressure plate 50B, which provides a mechanical interference preventing pin “P” from sliding inwardly entirely through the corresponding aperture.

The magnitude of the shank diameter corresponds to, and is slightly less than, the magnitude of the opening defined by the helical groove portion of groove “G” of drive hub 25B. Accordingly, the terminal ends of pins “P” are adapted and configured to be slidingly received by, and slide within, the helical portion of groove “G.”

When a force is applied to pins “P” in a direction which corresponds to the direction of extension of the helical portion of a groove “G,” namely toward the intersection of the helical section and non-helical section of a groove, the respective pin “P” is rotationally and axially urged upwardly in the helical portion of the groove “G” which correspondingly urges pressure plate 50B rotationally over drive hub 25B, and axially across/along the length of drive hub 25B and compressingly urges pressure plate 50B against disc pack assembly 28.

Pressure plate 50B is adapted and configured to drivingly cooperate with, and/or be coupled with, winding drum 16C by e.g. winding drum 16C and pressure plate 50B is coupled by the interfacing of corresponding structures of pressure plate 50B and winding drum 16C. The relatively lesser diameter portion of pressure plate 50B has a plurality of channels/grooves which correspond to elongate projections which extend medially inwardly of winding drum 16C, which enables a rotational force applied to winding drum 16C to transfer generally in direction and magnitude to a rotational force applied to pressure plate 50B enabling winding drum 16C and pressure plate 50B to rotate in unison.

Referring now to FIGS. 1B, 2B, 3A, and 3B, in use, a left cable 62A and a right cable 62B are wound about the outer surface of winding drum 16C. As illustrated in FIG. 1B, cables 62A and 62B extend from the winding drum 16C to load 66, such as an elevator car.

Weight of load 66 which passes through cables 62A, 62B, passes through winding drum 16C through the coupling interfacing of winding drum 16C and the relatively lesser diameter portion of pressure plate 50B, thus to clutch/brake assembly 14, and through the combination of keyway “K2” and slot 70, to drive shaft 68. Drive shaft 68 is connected to gear box 72, thence to the electric drive motor 74 which lifts and lowers load 66.

The weight of load 66, which passes through cables 62A, 62B, passes through winding drum 16C and from winding drum 16C to pressure plate 50B, and through the pins “P” which interface with the helical portions of grooves “G” of drive hub 25B. As the weight force passes to pins “P,” the pins “P” are urged further into the helical portions of grooves “G,” and as drive core 18 is held relatively static by e.g. the relatively static state of drive shaft 68, pressure plate 50B is urged to rotationally actuate, and axially actuate, as dictated by the helical interfacing structures of helical grooves “G” and pins “P,” whereby pressure plate 50B interfaces with, and applies an axial force to, disc pack assembly 28. As axial force is applied to disc pack assembly 28, the alternatingly stacked clutch discs 36 and friction discs 38 are urged closer to each other, which correspondingly increases the frictional interface therebetween.

The direction of rotation of the winding drum 16C is selected in combination with the directional pitch of the helical portion of grooves “G” so that the weight of load 66 causes pressure plate 50B to apply an axial force on clutch discs 36 and friction discs 38 of disc pack assembly 28 wherein the axial force is related to the magnitude of the weight of load 66.

The greater the weight of load 66, the greater the axial force which is transmitted to pressure plate 50B and, correspondingly, the greater the axial force which is applied by the combination of the stack of clutch discs 36 and friction discs 38. While load 66 is applying an axial force on clutch discs 36 and friction discs 38 through the helical portion of grooves “G” and pressure plate 50B, load 66 is simultaneously applying a rotational force to drive shaft 68, also through the helical portion of grooves “G” and pressure plate 50B, and in combination with disc pack assembly 28. However, braking elements 32A, 32B are oriented, by virtue of lands 42, to constantly resist rotation of the winding drums in the direction of downward movement of load 66.

Accordingly, the rotational force applied by the weight of load 66 tends to cause rotation of the drive shaft 68 enabling lowering of load 66, which requires rotation of the friction discs 38 against the resistance of braking elements 32A, 32B as applied at the inner surface of fixed housing 15B. Namely, braking elements 32A, 32B urge non-rotation of clutch discs 36 with respect to fixed housing 15B in the direction of downward movement of load 66, and thereby provide a mechanical load compensation by introducing a braking function to resist rotation of the winding drum in the downward load direction, in the absence of driving force from drive motor 74.

The cooperating spline/groove angles on the helical portions of grooves “G” are so selected that the downward rotational urge of the weight of load 66 on drive shaft 68 is always countered by enough axial loading of the clutch discs 36 and the friction discs 38 to effectively engage braking elements 32 against the inner surface of housing 15B, thereby to prevent frictional sliding of the friction discs 38 with respect to the clutch discs 36 under the gravitational weight of load 66 and movement of the braking elements 32A, 32B relative to housing 15B.

Namely, the spline/groove angle, in combination with the net friction between discs 36 and 38, and between brake elements 32 and housing 15B is such that any change in operating magnitude of load 66 is accompanied by a corresponding change in the axial force and braking force, sufficient to prevent downward movement of the load based on gravity forces alone.

Therefore in a static state, since the clutch discs 36 are prevented from rotating by braking elements 32, and since the winding drum 16C can only rotate when the friction discs 38 rotate, disc pack assembly 28 effectively prevents rotation of the winding drums when shaft 68 is not powered by motor 74 through gear box 72, whereby a passive braking force, as a mechanical load compensation, is realized in the static situation in which load 66 is automatically held at whatever is its elevation when motor 72 is stopped, by the braking action of disc pack assembly 28, including through the braking interfacing action of braking elements 32 against the inner surface of fixed housing 15B.

Accordingly, when load 66 is to be lowered, a shaft torque input, which drives drive shaft 68 in a first rotational direction, is required from motor 74 to drive through the passive braking force/mechanical load compensation which is applied by disc pack assembly 28 any time downward movement of the load is desired, in order to lower load 66.

When load 66 is to be lifted, the motor drives the gear box in a suitable direction, which drives drive shaft 68 in a second, opposite direction, namely in a lifting direction to lift load 66. Since lands 42 bias braking elements 32 only in the downward direction of movement of load 66, a lifting drive on shaft 68 releases the braking elements 32 from engagement with the inner surface of fixed housing 15B, whereby braking elements 32 can move generally downwardly into/across lands 42, relatively nearer the axis of rotation “A,” whereby the force required to lift load 66 approximates the free wheeling lifting force required of a drive system not having disc pack assembly 28.

In some embodiments, disc pack assembly 28 operates in a dry clutch environment. In other embodiments, disc pack assembly 28 operates in a wet clutch environment, wherein at least part of disc pack assembly 28 is submerged in a liquid lubricant and/or coolant, such as gear oil, automatic transmission fluid, or others. In such embodiments the interfaces between, for example gear box 72 and housing 15A, 15B, as well as others, include o-rings and/or other commonly known/used seals, which creates a generally liquid tight environment.

In yet other embodiments, winding drum 16C does not have a cavity formed therein. Rather, pressure plate 50 is mounted outside, yet adjacent, winding drum 16C, wherein winding drum 16C covers relatively less, or more of housing 15B. In some embodiments, winding drum 16C has a cavity which extends relatively further therein than the drums 16A, 16B illustrated. In such embodiments, winding drum 16C covers most, optionally all, of housing 15B.

Force transmission devices 8 are made of materials which resist corrosion in the expected use environment, and are suitably strong and durable for normal extended use. Those skilled in the art are well aware of certain metallic and non-metallic materials which possess such desirable qualities for use in force transmission devices, and appropriate methods of forming such materials.

Appropriate metallic materials for components of, or parts of components of, force transmission device 8 e.g. at least parts of sheave “S,” plate 10, winding assembly 11, gearbox 72, motor 74, and others, can be selected from but are not limited to, aluminum, steel, stainless steel, titanium, magnesium, brass, and their respective alloys. Common industry methods of forming such metallic materials include casting, forging, shearing, bending, machining, grinding, riveting, welding, powdered metal processing, extruding and others.

Non-metallic materials suitable for components of force transmission device 8, e.g. various seals/o-rings, parts of bearing assembly 17, friction discs 38, and others, can be selected from various polymeric compounds, such as for example and without limitation, various of the polyolefins, such as a variety of the polyethylenes, e.g. high density polyethylene, or polypropylenes. There can also be mentioned as examples such polymers as polyvinyl chloride and chlorinated polyvinyl chloride copolymers, various of the polyamides such as nylon which, for example, can be used in friction discs 38 as nylon is relatively heat tolerant compared to certain other cost effective polymeric materials; polycarbonates, and others.

For any polymeric materials employed in structures of the invention, any conventional additive package can be included such as, for example and without limitation, slip agents, anti-block agents, release agents, anti-oxidants, fillers, and plasticizers, to assist in controlling e.g. processing of the polymeric material as well as to stabilize and/or otherwise control the properties of the finished processed product, also to control hardness, bending resistance, and the like.

Common industry methods of forming such polymeric compounds will suffice to form such non-metallic components of force transmission device 8. Exemplary, but not limiting, of such processes are the various commonly-known plastics converting processes.

Individual components of force transmission device 8 can be assembled as subassemblies, including but not limited to, clutch/brake assembly 14 which includes housing 15A, 15B, disc pack assembly 28, and force converter 43A, 43B winding drum 16A, 16B, 16C, bearing assembly 17, cable 62A, 62B, gearbox 72, motor 74, and others. Each of the aforementioned sub-assemblies is then assembled to respective other ones of the sub-assemblies to develop force transmission device 8. Those skilled in the art are well aware of certain joinder technologies and hardware suitable for the assembly of such subassemblies in assembling force transmission device 8.

As can be seen from the above description of the illustrated embodiments, the force transmission devices of the invention receive a load typically in a straight line expression of one or more forces by cables 62A, 62B. The straight line force is converted to a rotational force at winding drum 16A, and 16B, or 16C. The rotational force is converted in part to a straight-line axial force causing e.g. movement of helical gear 44, and in part to a radial force in the frictional engagement of brake elements 32A, 32B, 32 between clutch plates 36 and the inner surface of housing 15A, 15B. In summary, a straight-line load force is converted first to a rotational/torsional force, and thereafter is converted to axial and radial forces.

In some embodiments, braking elements 32A, 32B, 32 are omitted from the assembly whereby the entirety of the rotational force is converted to the axial force, and no radial force is developed. In such case, force transmission device 8 operates as a clutch, but not as a brake, whereupon any desired braking function is provided by other structure.

Those skilled in the art will now see that certain modifications can be made to the apparatus and methods herein disclosed with respect to the illustrated embodiments, without departing from the spirit of the instant invention. And while the invention has been described above with respect to the illustrated embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

While the present invention is illustrated with reference to force transmission devices having particular configurations and particular features, the present invention is not limited to these configurations or to these features, and other configurations and features can be used.

Similarly, while the disclosure hereof is detailed and exact to enable those skilled in the art to practice the invention, the invention is embodied in other structures in addition to the illustrated exemplary structures. The scope of the invention is defined in the claims appended hereto.

1. A force transmission device, comprising:
(a) a prime mover;
(b) a clutch/brake assembly communicating with said prime mover;
(c) a winding drum communicating with said clutch/brake assembly; and
(d) a force converter communicating with said clutch/brake assembly and said winding drum and,
said clutch/brake assembly comprising a clutch/brake housing having a housing inner surface, a plurality of discs defining a collective outer perimeter surface, including at spaces between said discs, said discs being generally concentrically disposed within said clutch/brake housing, and at least one braking element disposed between said housing inner circumferential surface and the collective outer perimeter surface of said plurality of discs, thereby to realize a frictional coupling between said discs and the inner surface of said clutch/brake housing.

2. A force transmission device as in claim 1 wherein said at least one braking element communicates with the collective perimeter surface of said plurality of discs; and is adapted and configured to bias between a first position in which said at least one braking element is relatively frictionally engaged with the inner surface of said clutch/brake housing, and a second position in which said at least one braking element is relatively frictionally disengaged with the inner surface of said clutch/brake housing.

3. A force transmission device as in claim 1, said plurality of discs being adapted to rotate about an axis of rotation, each of said plurality of discs being generally circular and having opposing generally flat surfaces, and defining an outer perimeter, including an imaginary outer circumference, at least one of said discs having a disc land at the corresponding outer perimeter, and extending from such imaginary outer circumference, said land defining an angle greater than zero degrees relative to a tangent to such outer circumference, which tangent touches such imaginary outer circumference at a locus underlying or touching the land.

4. A force transmission device as in claim 3, said disc land having first and second terminal ends, said at least one braking element being movable along said disc land between a first position in which said at least one braking element is proximate one of the first and second terminal ends of said disc land, and a second position in which said at least one braking element is displaced from one of the first and second terminal ends of said disc land.

5. A force transmission device as in claim 3, said disc land having first and second terminal ends, said at least one braking element being rotationally movable along said disc land between a first position in which said at least one braking element is proximate one of the first and second terminal ends of said disc land, and a second position in which said at least one braking element is displaced from one of the first and second terminal ends of said disc land.

6. A force transmission device as in claim 1 wherein said clutch/brake assembly comprises a pressure plate, and at least one clutch disc having a generally serrated outer circumferential surface.

7. A force transmission device as in claim 6 wherein said clutch/brake assembly further comprises at least one friction disc coaxial with, and adjacent, at least one of said pressure plate and said clutch disc whereby said friction disc is adapted and configured to frictionally engage with at least one of said pressure plate and said clutch disc.

8. A force transmission device as in claim 1, further comprising a drive shaft having a length and an outer circumferential surface and communicating with said prime mover and extending generally medially axially through said clutch/brake assembly and said winding drum.

9. A force transmission device as in claim 1 wherein said force converter comprises a generally cylindrical body having an outer perimeter surface and at least one groove in the outer perimeter surface.

10. A force transmission device as in claim 9 wherein said force converter has an axis of rotation and said at least one groove of said generally elongate cylindrical body defines a first groove portion and a second groove portion, one of the first and second groove portions being generally parallel to the axis of rotation and the other of the first and second groove portions extending generally helically along a portion of the outer perimeter surface of said generally cylindrical body of said force converter.

11. A force transmission device as in claim 1, further comprising a pressure plate having first and second generally annular ends, one of said first and second generally annular ends generally defining a collar, and a cavity extending from the collar inwardly into said pressure plate, said force transmission device yet further comprising a generally cylindrical body having an outer circumferential surface, at least a portion of said generally cylindrical body of said force transmission device being generally slidingly and rotatably housed in at least a portion of the cavity of said pressure plate, said pressure plate being adapted and configured to generally axially slide with respect to, and to generally rotate with respect to, said generally cylindrical body of said force transmission device.

12. A force transmission device as in claim 11, said pressure plate being adapted and configured to axially and rotatably actuate between a first position in which relatively less of said generally cylindrical body is covered by said pressure plate, and a second position in which relatively more of said generally cylindrical body is covered by said pressure plate.

13. A force transmission device as in claim 12 wherein when said pressure plate is in the first position, ones of said plurality of discs generally rotationally slip with respect to each other.

14. A force transmission as in claim 12 wherein when said pressure plate is in the second position, ones of said plurality of plates generally frictionally couple with respect to each other.

15. A force transmission device as in claim 13, said at least one braking element communicating with the collective outer perimeter surface of said plurality of plates and generally loosely interfacing with the inner circumferential surface of said clutch/brake housing.

16. A force transmission device as in claim 14, said at least one braking element communicating with the collective outer perimeter surface of said plurality of plates and generally snugly interfacing with the inner circumferential surface of said clutch/brake housing, whereby said at least one braking element provides frictional braking force against the inner circumferential surface of said clutch/brake housing.

17. A force transmission device as in claim 4 further comprising an interfacing plate between said disc land and said at least one brake element.

18. A force transmission device, comprising:
(a) drive shaft;
(b) a force converter comprising a first actuation member and a second actuation member, said force converter being drivingly engaged with said drive shaft;
(c) a clutch communicating with said force converter; and
(d) a winding drum drivably engaged with said force converter;
said first actuation member and said second actuation member being engaged with each other so as to effect axial movement of at least one of said first and second actuation members relative to the other of said first and second actuation members, and wherein the axial movement of the at least one of said first and second actuation members corresponds to respective engagement and/or disengagement of said clutch.

19. A force transmission device as in claim 18 wherein said device further comprises a brake communicating with said clutch and comprising a brake housing having at least one braking element engagably communicating with said brake housing.

20. A force transmission device as in claim 19 wherein said brake housing is generally concentric with, and generally surrounds said clutch.

21. A force transmission device as in claim 19, said clutch defining an outer perimeter surface and said brake housing comprising an inner circumferential surface, at least one braking element communicating with each of said outer perimeter surface of said clutch and said inner circumferential surface of said brake housing.

22. A force transmission device as in claim 21, said clutch being adapted and configured to rotate about an axis of rotation, said at least one braking element being adapted and configured to bias between a first position in which said braking element is relatively frictionally engaged with the inner surface of said brake housing, and a second position in which said braking element is relatively frictionally disengaged with the inner surface of said brake housing.

23. A force transmission device as in claim 18 wherein said clutch comprises a plurality of discs, as said actuation members, adapted and configured to rotate about an axis of rotation, each of said plurality of discs being generally circular and having opposing generally flat surfaces, and defining an outer perimeter, including an imaginary outer circumference, at least one of said discs having a disc land at the corresponding outer perimeter, and extending from such imaginary outer circumference, said land defining an angle greater than zero degrees relative to a tangent to such outer circumference, which tangent touches such imaginary outer circumference at a locus underlying or touching the land.

24. A force transmission device as in claim 23 wherein said at least one braking element has a length extending generally parallel to the axis of rotation, said braking element being adapted and configured to move with respect to said disc land.

25. A force transmission device as in claim 23, said disc having first and second terminal ends, said at least one braking element being slidably moveable along said disc land between a first position in which said at least one braking element is proximate one of the first and second terminal ends of said disc land, and a second position in which said at least one braking element is displaced from the one of the first and second terminal ends of said disc land.

26. A force transmission device as in claim 23 further comprising an interfacing plate between said disc land and said at least one brake element.

27. A force transmission device comprising:
(a) a drive shaft;
(b) a force converter drivingly engaged with said drive shaft; and
(c) a winding drum drivably engaged with said force converter;
said force converter further comprising a first actuation member and a second actuation member, said force converter being adapted and configured so as to enable at least one of said first and second actuation members to axially move relative to the other of said first and second actuation members, whereby a torsional force applied to at least one of said first actuation member and said second actuation member realizes an axial advancement or regression of at least one of said first actuation member and said second actuation member relative to the other one of said first actuation member and said second actuation member.

28. A force transmission device as in claim 27 wherein the at least one of the first and second actuation members moves axially when a torsional force is applied to the actuation member.

29. A force transmission device as in claim 27 wherein at least one of said first and second actuation members is adapted and configured to rotate in combination with axial movement relative the other of the first and second actuation members.

30. A force transmission device as in claim 27 wherein said force converter comprises a generally cylindrical body having an outer perimeter surface, and at least one groove in the outer perimeter surface.

31. A force transmission device as in claim 30 wherein said force converter has an axis of rotation and said at least one groove of said generally elongate cylindrical body defines a first groove portion and a second groove portion, one of the first and second groove portions being generally parallel to the axis of rotation and the other of the first and second groove portions extending generally helically along a portion of the outer perimeter surface of said generally cylindrical body of said force converter.

32. A force transmission device as in claim 27, further comprising a pressure plate having first and second generally annular ends, one of said first and second generally annular ends generally defining a collar and a cavity extending from the collar inwardly into said pressure plate, said force transmission device yet further comprising a generally elongate cylindrical body having an outer circumferential surface, at least a portion of said generally cylindrical body of said force transmission device being generally slidingly and rotatably housed in at least a portion of the cavity of said pressure plate, said pressure plate being adapted and configured to generally axially slide with respect to, and to generally rotate with respect to, said generally cylindrical body of said force transmission device.

33. A force transmission device as in claim 32, said pressure plate being adapted and configured to axially and rotatably actuate between a first position in which relatively less of said generally cylindrical body is covered by said pressure plate, and a second position in which relatively more of said generally cylindrical body is covered by said pressure plate.

34. A force transmission device as in claim 33 wherein said device further comprises a clutch communicating with said force converter and having a plurality of discs generally defining an outer perimeter surface, including space between said discs, and wherein said pressure plate in the first position corresponds to a generally rotationally slipping relationship between ones of said plurality of discs.

35. A force transmission device as in claim 33 wherein such device further comprises a clutch communicating with said force converter said clutch having a plurality of discs generally defining an outer perimeter surface, including spaces between said discs, and wherein said pressure plate in the second position corresponds to a generally frictional coupling relationship between respective ones of said plurality of discs.

36. A force transmission device as in claim 34 wherein such device further comprises a brake having a clutch/brake housing which defines an inner circumferential housing surface, and at least one braking element, said at least one braking element communicating with said outer perimeter surface of said plurality of discs and, in the first position, generally loosely interfacing with the inner circumferential surface of said clutch/brake housing.

37. A force transmission device as in claim 35 wherein said device further comprises a brake, and a clutch/brake housing which defines an inner circumferential housing surface, and at least one braking element, said at least one braking element communicating with said outer perimeter surface of said plurality of discs and, in the second position, generally snugly interfacing with the inner circumferential surface of said clutch/brake housing, whereby said at least one braking element provides a frictional braking force between the inner circumferential surface of said clutch/brake housing and the outer perimeter surface of said plurality of discs.

38. A force transmission device as in claim 34 wherein said device further comprises a brake housing and a brake element between said brake housing and said plurality of discs, and a interface plate between said brake element and said plurality of discs.

39. A force transmission device as in claim 27 wherein one of said first and second actuation members has an outer surface, and grooves disposed in the outer surface, and wherein the other one of said first and second actuation members comprises a collar having an inner surface with projections extending inwardly at the inner surface, said projections cooperating with the grooves in the outer surface.

40. A force transmission device as in claim 39 wherein said grooves in the outer surface are adapted and configure to guide movement of one of said projections of said collar and said other one of said first and second actuation members, upon application of a rotational force to said one of said actuation members, in a direction of an axis extending through said generally cylindrical body.

41. A force transmission device as in claim 39, said collar having an outer surface communicating with said winding drum whereby a torsional force applied to said winding drum is transferred to said collar.

42. A force transmission device as in claim 27 wherein said first actuation member comprises a helical gear, and wherein said second actuation member comprises a ring gear cooperatively compatible with said helical gear, said helical gear and said ring gear being rotatably slidingly engaged with each other.

43. A force transmission device as in claim 27, said force converter being adapted to convert a torque force applied to a first one of said first and second actuation members into axial movement of one of said first and second actuation members.

44. A drive-through clutch/brake comprising:
(a) a clutch assembly including at least one clutch disc, at least one friction disc, a helical gear, and a helical drive;
(b) a brake housing;
(c) at least one brake element effective to engage said clutch assembly at said at least one clutch disc and/or said at least one friction disc, and said brake housing.

45. A drive-through clutch/brake as in claim 44, said clutch assembly capable of rotating in a first direction of driving whereby said at least one brake element is generally disengaged from said brake housing.

46. A drive-through clutch/brake as in claim 44, said clutch assembly capable of rotating in a second, opposite, direction of driving whereby said at least one brake element is generally engaged with said brake housing and remains engaged with said brake housing during rotation of said clutch assembly in such second direction.

47. A method of automatically controlling a load, comprising:
(a) suspending a gravitationally-actuated load from a force transmission device, the force transmission device comprising a winding drum, a force converter, and a brake;
(b) transferring the gravitationally actuated load through a cable, to said winding drum and thereby converting the gravitational force to a torsional force;
(c) transferring at least some of the force from the winding drum, through the force converter, and into the brake; and
(d) converting at least some of the torsional force from the winding drum into axial movement, and thereby developing a braking force in the brake.

48. A method as in claim 47 wherein the force transmission device further includes a prime mover, and a drive train connecting the prime mover to the force transmission device, the method further comprising:
(e) energizing the prime mover so as to provide a rotational driving force, through the drive train, to the force converter, in a first rotational direction and correspondingly rotating said winding drum in a first direction of rotation and thereby removing at least part of the braking force from the brake;
the magnitude of the braking force removed from said brake being sufficient to enable the prime mover to lift the load.

49. A method as in claim 48, the method further comprising:
(f) energizing the prime mover so as to provide a rotational driving force in a second, opposite rotational direction and correspondingly rotating the winding drum in a second, opposite direction of rotation; and
(g) rotating the winding drum with a magnitude of rotational driving force sufficiently great to overcome the braking force provided by the brake;
whereby the magnitude of the rotational driving force is sufficiently great to enable the prime mover to drive through the braking force of the brake and correspondingly to lower the load.

50. A method of controlling a load, comprising:
(a) applying a loading force, in a loading direction, to a force transmission device comprising a force receiver, a force converter, and a brake;
(b) applying sufficient braking energy to the brake to prevent the loading force from causing motion; and
(c) applying driving energy from a prime mover to the force transmission device, in a direction such that the driving energy force is additive to the loading force, and in sufficient amount to overcome the braking force provided by the brake, thereby to enable movement of the load in accord with the direction of the loading force while the braking energy is being applied.

51. A method of controlling a load as in claim 50, the method further comprising:
(d) applying driving energy from a prime mover to the force transmission device, in a direction generally opposite the direction of the loading force, and in sufficient amount to reduce the braking force provided by the brake, thereby to enable movement of the load in accord with the direction of the driving energy force and generally opposite the direction of the loading force.
